(19) United States
(12) Patent Application Publication
(10) Pub. No.: US 2026/0117519 A1
(43) Pub. Date: Apr. 30, 2026

(54) STRUCTURE SYSTEMS, STRUCTURES WITH INTEGRATED SOLAR RACKING SYSTEMS, POST AND FRAME COMPONENTS, AND RELATED METHODS

(71) Applicant: Infinity Rack LLC, Cornelius, NC (US)

(72) Inventor: Christopher L Verner, Charlotte, NC (US)

(73) Assignee: Infinity Rack LLC, Cornelius, NC (US)

(21) Appl. No.: 19/151,207

(22) PCT Filed: Jan. 29, 2024
(86) PCT No.: PCT/US2024/013388

§ 371 Date: Jul. 25, 2025

Related U.S. Application Data
(60) Provisional application No. 63/482,002, filed on Jan. 27, 2023.

(51) Int. Cl. E04B 7/04; E04B 1/24; H02S 20/25; H02S 30/10; H02S 40/10

(52) U.S. Cl. CPC E04B 7/04; E04B 1/2403; E04B 2001/2415; E04B 2001/2418; E04B 2001/2475; E04B 2001/2487; E04B 2001/249; H02S 20/25; H02S 30/10; H02S 40/10

(57) ABSTRACT

The present subject matter relates to structure systems, including structures with integrated solar racking systems, frame systems, post and frame components, and related methods. In particular, the present subject matter relates to posts and frame components that form a frame system that can be used to support a roofing system. The frame system and roofing system can forma structure system. The roofing systems can include integrated solar panels in the roofing structure and/or support the use of insulated roofing panels for non-solar applications to form a roofing system for a building, a structure, or a canopy.

### RELATED APPLICATIONS

The presently disclosed subject matter claims the benefit of PCT International Patent Application Serial. No. PCT/US2024/013388, filed Jan. 29, 2024, and U.S. Provisional Patent Application Ser. No. 63/482,002, filed Jan. 27, 2023, to which PCT International Patent Application Serial. No. PCT/US2024/013388 claims priority and benefit. The disclosures of both patent applications referenced above are incorporated herein by reference in their entireties.

### TECHNICAL FIELD

The present subject matter relates to structure systems, including structures with integrated solar racking systems, frame systems, post and frame components, and related methods. In particular, the present subject matter relates to structure systems that can be provided for integration of solar panels or use of insulated roofing panels for non-solar applications to form a roofing system for a building or other structure as well as frame systems that can be used to support a roofing system.

### BACKGROUND

There has been an increasing demand of utilizing solar energy as a clean alternative for individual homes. Solar modules are of particular interest and are widely utilized and installed in a solar rack that resides on top of the existing roof of a house or other building. Generally, each of the solar modules can be arranged in an array and held between vertical rails in a racking system secured onto an existing roof. These solar racking system installations are typically not watertight as racks are affixed upon an existing roof. In these racking systems, rainwater leakage can become a problem. The rainwater seeps down through joints between the frame of the solar module and the vertical rail of the racking system and onto the roof. Such leakage as well as other issues encountered when mounting the racking system on the roof make such racking system installations less desirable, even when weighed against the benefits of solar power.

While there are existing racking structures that offer “watertight” solutions, they are less durable, more expensive to produce and construct, and much more complicated to install and assemble. For example, certain leading alternatives rely on wooden rafters or girders which can lead to rot and degradation of the structural integrity of the roof below the racking system. Racking systems are complicated and contain a multitude of parts which makes assembly complicated and makes user error more likely during installation. Existing watertight solutions rely on exposed commercial/roofing seam tape or ethylene propylene diene monomer rubber (EPDM) gaskets that are exposed to the sun and other elements which results in degradation over time and a typical maximum lifespan of around three (3) years before replacement is needed. Racking structures that do not rely on the seam tape or EPDM gaskets to create a watertight seal have purlin caps that protrude from between the solar panels or insulated metal plates that create water dams which cause water to pool leading to mold and waste buildups that can degrade and break the watertight seal over time and obstruct the energy collection of the solar panels.

To combat such issues that arise with solar module array installations that are secured to existing roofs, the construction industry stands to gain by integrating solar modules into roof assemblies in new construction or when replacing a roof on an existing structure. For such solar roof assembly installation, though, there are few options available for a fully integrated roofing system that include the structural member required and there are no options that offer reliable, lasting, watertight protection.

Additionally, for racking systems that form a roof of a structure, depending on the materials and components used, the post and frames that are used to support the racking structures can create opportunity for instability and provide less flexibility for forming and resetting the racking, or roof, structure.

As such, in general construction and solar installation, a need exists to create an easy to assemble, long lasting, watertight roof assembly that reduces the number of steps required, reduces labor costs, and simplifies the process of both general roof construction as well as solar integration within a roof that can be used on structures of all types.

### SUMMARY

The present subject matter relates to structure systems, frame systems, post and frame components, and related methods. In particular, the present subject matter relates to posts and frame components for supporting roofing systems and integrated solar panels in the roofing structure and/or that support the use of insulated roofing panels for non-solar applications to form a roofing system for a building, structure, or canopy as well as frame systems that can be used to support a roofing system. Methods related to the manufacture and assembly of the posts and frame components for supporting roofing systems disclosed herein are also provided.

Thus, it is an object of the presently disclosed subject matter to provide structure systems, frame structures, and post and frame components that support the integration of solar panels or insulated roofing panels for non-solar applications into a roof to form a roofing system for a building, structure, or canopy. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1A illustrates a perspective view of an embodiment of a structure system that includes embodiments of solar panels as an outer surface of the roof according to the present subject matter;

FIG. 1B illustrates a perspective view of another embodiment of a structure system that includes embodiments of solar panels as an outer surface of the roof according to the present subject matter;

FIG. 2 illustrates a perspective view of an example embodiment of a base building structure according to the present subject matter on which an embodiment of a roofing system can be installed;

FIGS. 3A and 3B illustrates a perspective view of portions of the base building structure according to FIG. 1B with embodiments of post beams and frame beams as well as brackets of a roofing system according to the present subject matter being installed;

FIG. 4A illustrates a side plan view showing a portion of a post beam and post base that form a column of the base building structure according to FIG. 1B according to the present subject matter;

FIG. 4B illustrates a first side view, a second side view, and a top view of a post base that facilitates the formation of a column of the building structure according to FIG. 1B according to the present subject matter;

FIG. 4C illustrates a cross-sectional view of an embodiment of a post beam that facilitates the formation of a column of the building structure according to FIG. 1B according to the present subject matter;

FIG. 4D illustrates a cross-sectional view of another embodiment of a post beam that facilitates the formation of a column of the building structure according to FIG. 1B according to the present subject matter;

FIG. 4E illustrates a side view and a cross-sectional views of a post beam that facilitates the formation of a column of the building structure according to FIG. 1B according to the present subject matter;

FIG. 4F illustrates a cross-sectional view of an embodiment of a frame beam that facilitates the formation of the building structure according to FIG. 1B according to the present subject matter;

FIG. 4G illustrates a cross-sectional view of another embodiment of a frame beam that facilitates the formation the building structure according to FIG. 1B according to the present subject matter;

FIG. 4H illustrates a side view and a cross-sectional views of a frame beam that facilitates the formation of the building structure according to FIG. 1B according to the present subject matter;

FIG. 4I illustrates a cross-sectional view of an embodiment of a center structural beam that can be used in an embodiment of a post beam according to the present subject matter;

FIG. 4J illustrates a cross-sectional view of another embodiment of a post beam according to the present subject matter that uses multiple structural beams including the center structural beam according to FIG. 4I;

FIG. 5A illustrates a side view, a cross-sectional view, and a top view of an embodiment of a T frame according to the present subject matter;

FIG. 5B illustrates a front plan view of an embodiment of a T bracket that is secured to a column and frame beams of the building structure according to the present subject matter;

FIG. 5C illustrates a front view, a side view, and a top view of an embodiment of a T bracket according to the present subject matter;

FIG. 6A illustrates a side plan view showing a portion of an embodiment of a brace bracket according to the present subject matter that is secured to a column to facilitate support of frame beams of the building structure according to FIG. 1B;

FIG. 6B illustrates a first side view, a second side view, and a top view of an embodiment of a right side brace bracket according to the present subject matter;

FIG. 6C illustrates a first side view, a second side view, and a top view of an embodiment of a left side brace bracket according to the present subject matter;

FIG. 7A illustrates a side plan view showing embodiments of L brackets according to the present subject matter that is secured to a column to facilitate support of a frame beam of the building structure according to FIG. 1B;

FIG. 7B illustrates a side view, a bottom view, and a top view of an L bracket that according to the present subject matter;

FIG. 8A illustrates a side plan view showing a portion of embodiments of a frame beam, a rafter beam, and a U bracket used to secure the frame beam and rafter beam together according to FIG. 1B according to the present subject matter;

FIG. 8B illustrates cross-sectional view of an embodiment of a frame beam according to the present subject matter;

FIG. 8C illustrates a first side view, a second side view, and a top view of an embodiment of a U-bracket according to the present subject matter;

FIGS. 9A and 9B illustrate perspective views of portions of the base building structure according to FIG. 1B showing installation of wires into wire troughs according to the present subject matter;

FIG. 10A illustrates a cross-sectional view of a portion of an embodiment of the roofing system according to present subject matter showing the solar modules laid side-by-side with a seal secured between the solar modules;

FIG. 10B illustrates a cross-sectional view of a portion of an embodiment of the roofing system according to the present subject matter showing the solar modules laid side-by-side as shown in FIG. 10A and secured between the gaskets of the roofing system; and

FIG. 10C illustrates an end side plan view of an embodiment of the gaskets as shown in FIG. 10B used in conjunction with roofing panels or solar panels of the roofing system according to the present subject matter;

FIGS. 11A, 11B, and 11C illustrate perspective views of portions of the base building structure according to FIG. 1B showing installation of gaskets on the support beams of the roofing system according to the present subject matter;

FIGS. 12A, 12B, and 12C illustrate perspective views of portions of the base building structure according to FIG. 1B showing installation of solar panels/roofing panels on the support beams of the roofing system according to the present subject matter;

FIGS. 13A and 13B illustrate perspective views of portions of the base building structure according to FIG. 1B showing installation of top caps over the solar panels/roofing panels and secured on the support beams of the roofing system according to the present subject matter;

FIGS. 14A and 14B illustrate perspective views of portions of the base building structure according to FIG. 1B showing installation of top caps over the solar panels/roofing panels and secured on the support beams of the roofing system according to the present subject matter;

FIG. 15A illustrates a cross-sectional view of another embodiment of a support beam of a roofing system that includes embodiments of gaskets, end fins, a wire trough, and a top cap according to the present subject matter;

FIG. 15B illustrates a cross-sectional view of another embodiment of a support beam of a roofing system that includes embodiments of a wire trough and a top cap according to the present subject matter;

FIG. 16 illustrates side, cross-sectional, and top views of a wall bracket that is securable to a post beam to facilitate securement to a wall of another structure according to the present subject matter; and

FIG. 17 illustrates a side plan view of an embodiment of an edge strip according to the present subject matter.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc., may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Similarly, when a component, layer or coating is being described in the present disclosure as “on” or “over” another component, layer, or substrate, it is to be understood that the components or layers can either be directly contacting each other or have another component, layer or feature between the components or layers, unless expressly stated to the contrary. Thus, these terms are simply describing the relative position of the components or layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

As used herein, the term “solar modules” and “solar panels” are generally used interchangeably and refer to a single photovoltaic panel that is an assembly of connected solar cells. The solar cells absorb sunlight as a source of energy to generate electricity. An array of solar modules can be used to collect and supply power to a variety of structures and/or apparatuses.

As used herein, the term “roofing panels” is used broadly to mean any type of roofing panel and can include, but is not limited to solar modules, or solar panels, insulated roofing panels that do not include solar cells, or other roofing panels.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points. Thus, it is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

The present disclosure relates to a structure system for forming a structure with a roof that can include solar modules and/or insulated roofing panels, i.e., weatherproof roofing panel, which in some embodiments can be insulated metal plates, which form the majority of the outer surface of the roof. The structure system can include a frame structure that can include post beams and post bases that can form columns and frame beams and include a roofing system that includes rafter beams and panels, such as solar modules and/or insulated roofing panels. For example, the structure system can include roofing systems, roofing systems with integrated solar racking systems, roofing systems components, and related methods as disclosed and taught in U.S. Provisional Patent Application Ser. No. 63/150,569, filed Feb. 17, 2021, and PCT International Patent Application No. PCT/US2022/016881, filed Feb. 17, 2022, and published as International Patent Publication No. WO 2022/178189, the disclosure of these documents being incorporated herein by reference in their entireties.

The structure system as disclosed herein can comprise a frame system and a roofing system. The frame system can comprise a plurality of post beams and a plurality of frame beams. Each of the post beams of the plurality of post beams can have one or more post slots along at least a first side wall of the post beam. The frame system can also include a plurality of post bases corresponding to the plurality of post beams. Each of the post bases can comprise side walls with an aperture formed at a top of the post base for receiving a corresponding post beam of the plurality of post beams. The post base can include a base shelf extending from at least one of the walls of the post base configured to support a bottom end of the corresponding post beam. Further, post bases can further comprise one or more base slots that can be aligned with the post slots in the first side wall of the side walls of the post beam. The frame system of the structure system can also comprise a plurality of frame beams. Each of the frame beams of the plurality of frame beams can have one or more frame slots along at least a first side wall and a second side wall of frame beam. The frame system can also comprise a plurality of T-frames. Each T-frame can be configured to extend upward from a top end of a corresponding post beam of the plurality of post beams. Each T-frame can have a post receiving aperture for receiving the top end of the corresponding post beam and a frame beam groove positioned above the post receiving aperture for receiving one or more frame beams of the plurality of frame beams. Additionally, the frame system can comprise a plurality of brackets for securing corresponding post beams of the plurality of post beams and corresponding frame beams of the plurality of frame beams together.

The roofing system of the structure system can be secured to and can reside above the frame structure. The roofing system can comprise a plurality of rafter beams. Each of the rafter beams can comprise an extruded aluminum structural beam. The roofing system can also comprise roofing panels comprising at least one of an insulated roofing panel or a solar module. For example, in some embodiments, the roofing system can also comprise roofing panels comprising roofing panels selected from a group consisting of an insulated roofing panel or a solar module. Additionally, the roofing system can comprise a plurality of top caps corresponding to the number of the structural beams. The top caps can be configured to secure the roofing panels in place on the structural beams. Further, the roofing system can comprise gaskets for sealing the roofing panels and end fins attachable to at least one of the structural beams or the top caps to enclose end edges of the roofing system. The roofing system can also comprise one or more interior gutters built into each of the structural beams to drain any water that leaks between the gaskets and the roofing panels.

In some embodiments where solar modules are used as roofing panels, the roofing system can comprise wire troughs configured to accommodate wiring for solar modules used as roofing panels. Each of the wire troughs can be attached to a side of a structural beam. Additionally, in such embodiments, the one or more structural beams can further comprise a bonding rail. The bonding rail, or bonding jumper rail, can be used for clipping standard UL listed bonding jumpers between a solar module and a beam. Additionally, in some embodiments, the bonding rail can also be used to clip optimizers/microinverters in the same way these devices clip to a solar module frame.

In some embodiments, the structural beams can comprise one or more T-bolt slots therein. The T-bolt slots, for example, can be used for attaching wire troughs and attaching insulation covers and other accessory attachment as well as for securing bolts to the respective structural beam for securement of structural attachment brackets for securing the respective structural beam to a building structure being roofed. Each of the structural beams can also comprise a threaded channel on a top portion of the respective structural beam for securing a top cap to the respective structural beam.

The roofing system disclosed herein is not only novel to the solar industry, but also to the general construction industry as well. The roofing system allows for a less expensive and more durable alternative for the general construction industry for new buildings, modular or prefabricated homes, and kit construction, such as for homes and outbuildings. The roofing system disclosed herein can be considered “kit-like” in that it can come partially pre-assembled and can include easy to assemble components. It can also increase the accessibility of building integrated photovoltaics (“BIPV”) for a number of building types, reducing both a cost and complication barrier to installation.

In roofing and general construction, the use of the structural beams of the roofing system disclosed herein can allow for large unsupported spans while creating a roofing system with a far superior lifespan compared to traditional roofing methods. The weatherproof roofing panels, which can comprise insulated metal plates, can be sandwiched into the beam system between the structural beams and the top caps. As stated above, this beam system can incorporate an internal backup gutter system to facilitate the removal of moisture from the roofing system. Thus, whether or not solar photovoltaic solar modules are integrated therein, the roofing system disclosed herein will create a durable, sound roofing structure for a variety of structure types.

Thus, the present disclosure provides a frame system that can be used to support a roofing system. The present disclosure also provides a structural system that includes a frame system and a roofing system that uses structural beams. The roofing system can use top caps that can secure and hold multiple types of solar modules and insulated weatherproof roofing panels in a watertight, shingle-like assembly using roofing panel gaskets in a racking system, thereby providing a racking system that is integrated into the roofing structure of a building. The entire roofing system is designed to meet the typical structural requirements of a roof and/or solar array with a unique design, as explained further below with reference to the figures, which provides an all-in-one solution with long-term structural and watertight fortitude.

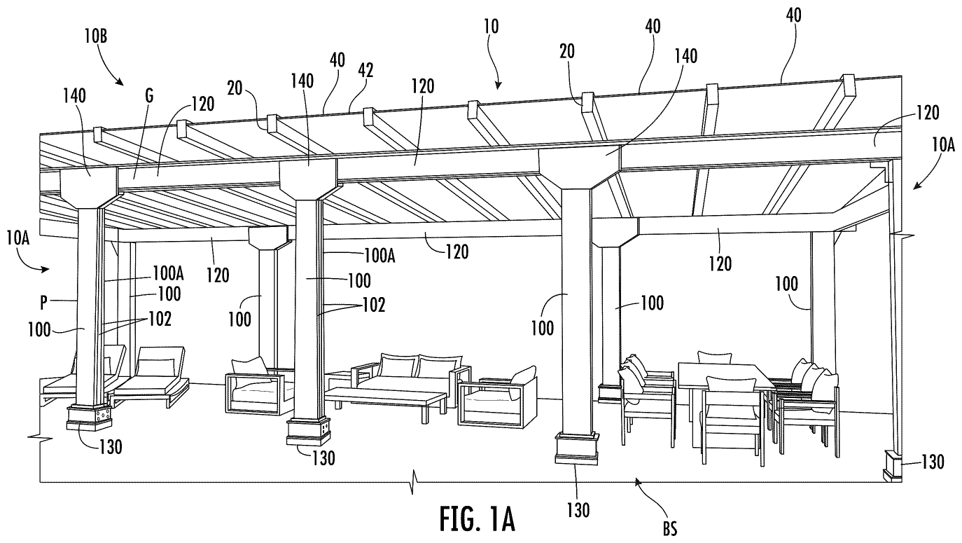

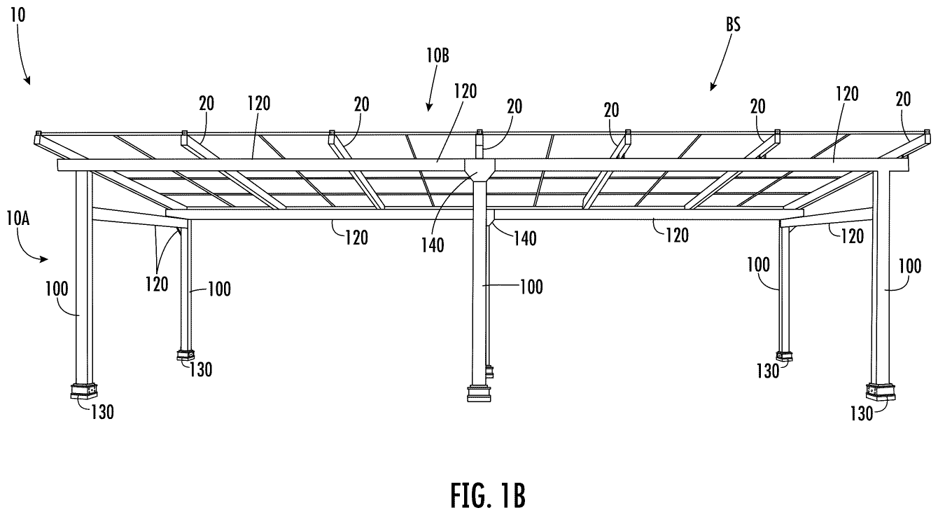

A building structure, generally, BS, is provided as shown in FIGS. 1A and 1B that includes a structure system, generally designated 10, that can incorporate roofing panels that can be either solar modules or insulated roofing panels. The structure system can include a frame system 10A and a roofing system 10B. Thus, a structure system 10 can be provided that operate as a regular roofing structure or a roofing structure that operates as both a roof and an integrated solar rack. The building structure BS is used herein simply for illustrative purposes only. It is noted that the structure system 10 can be used on any type of building and can include an array of roofing styles.

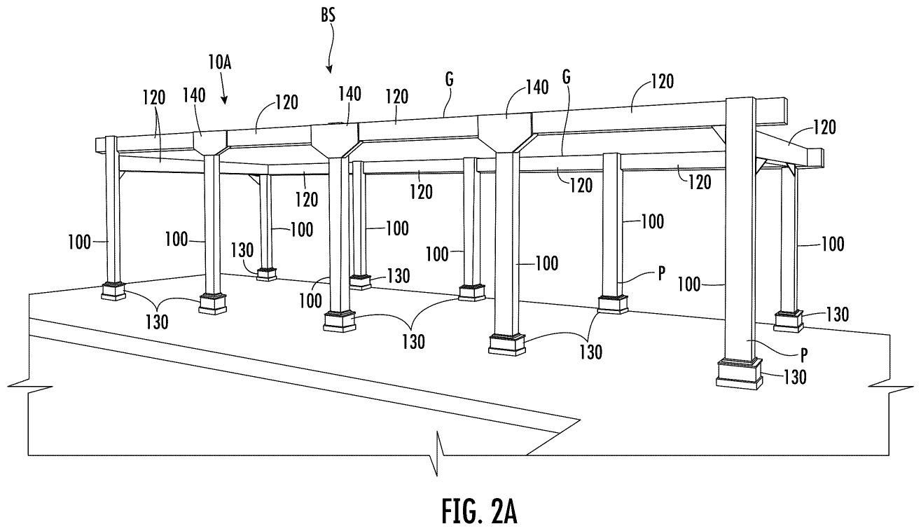

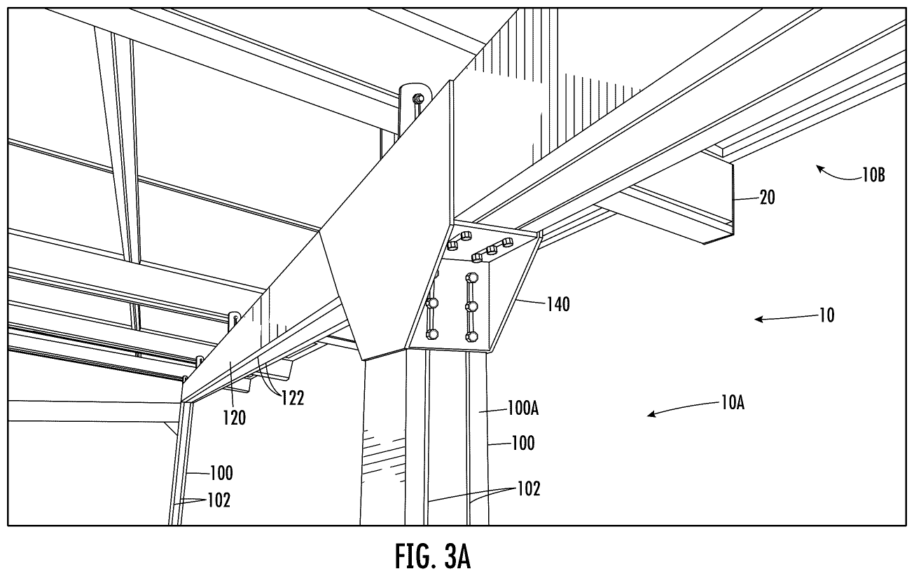

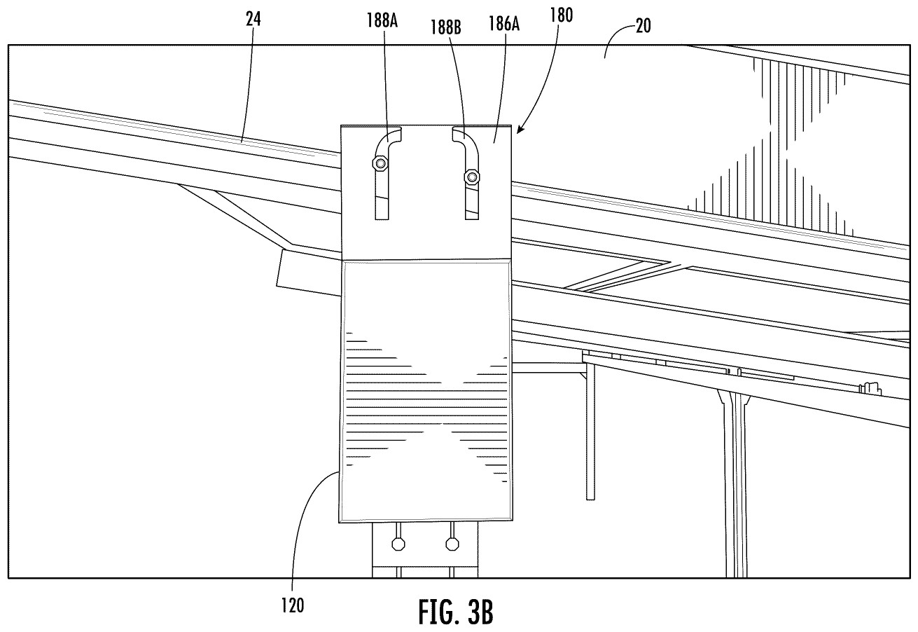

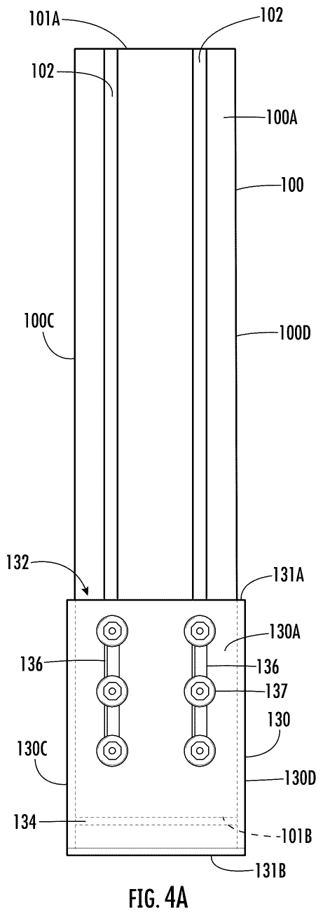

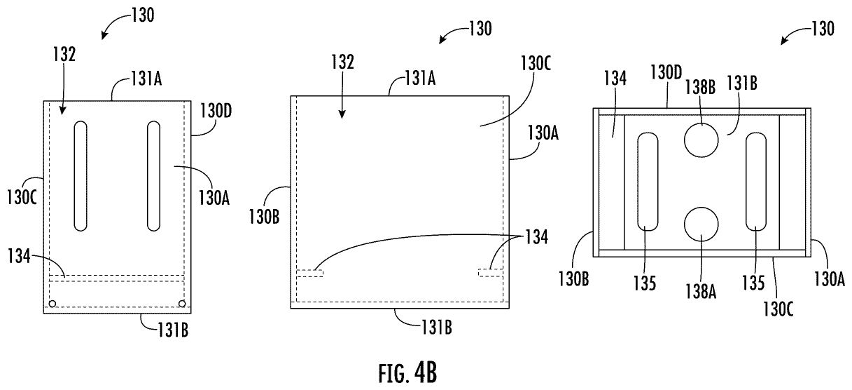

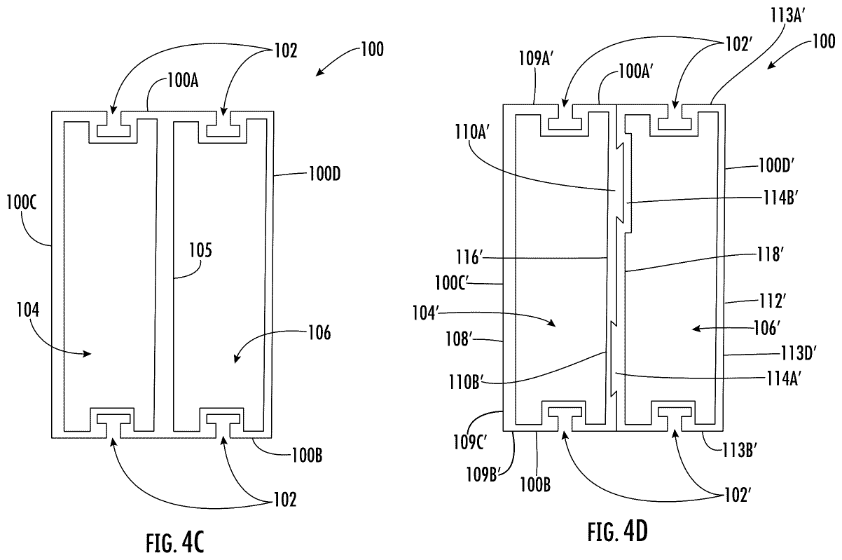

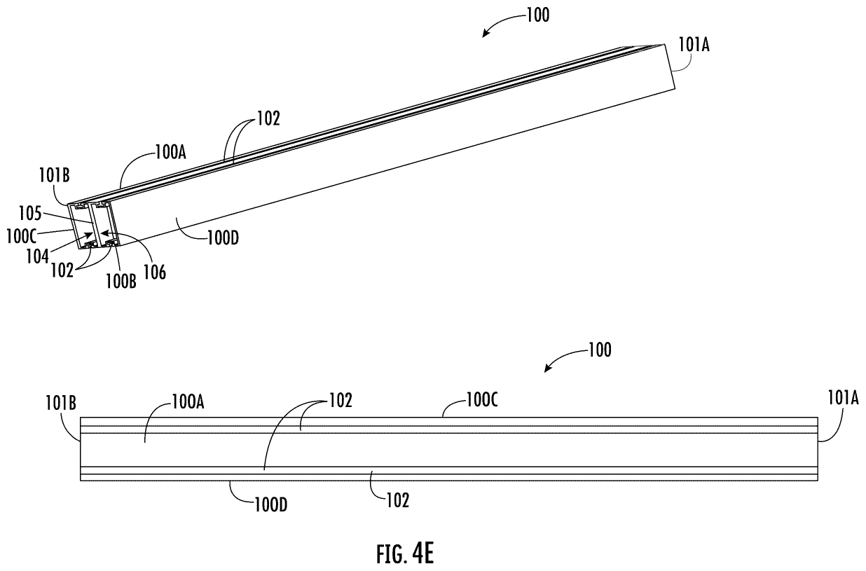

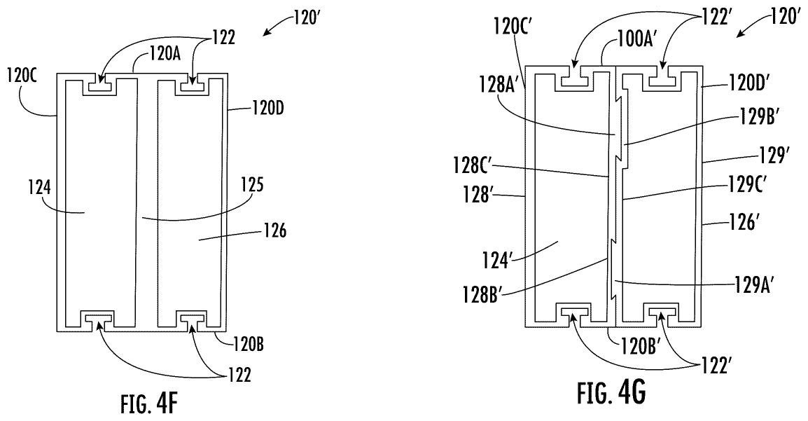

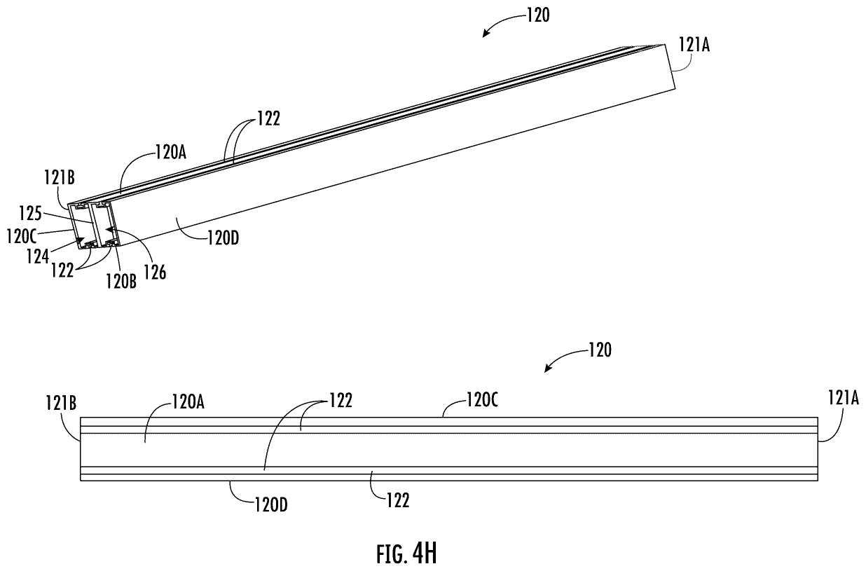

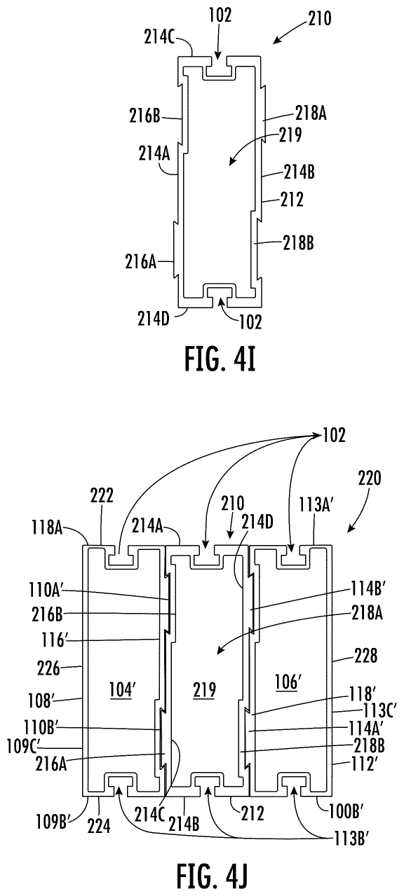

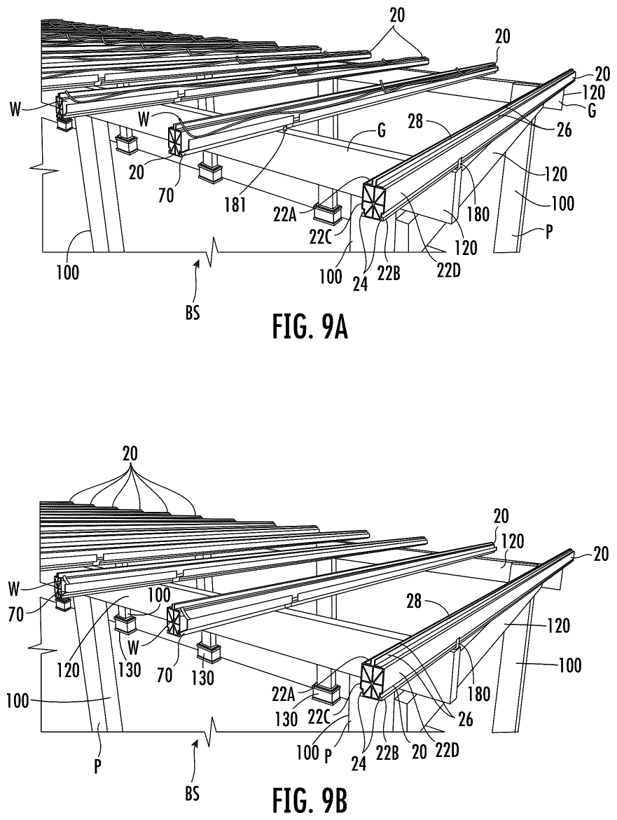

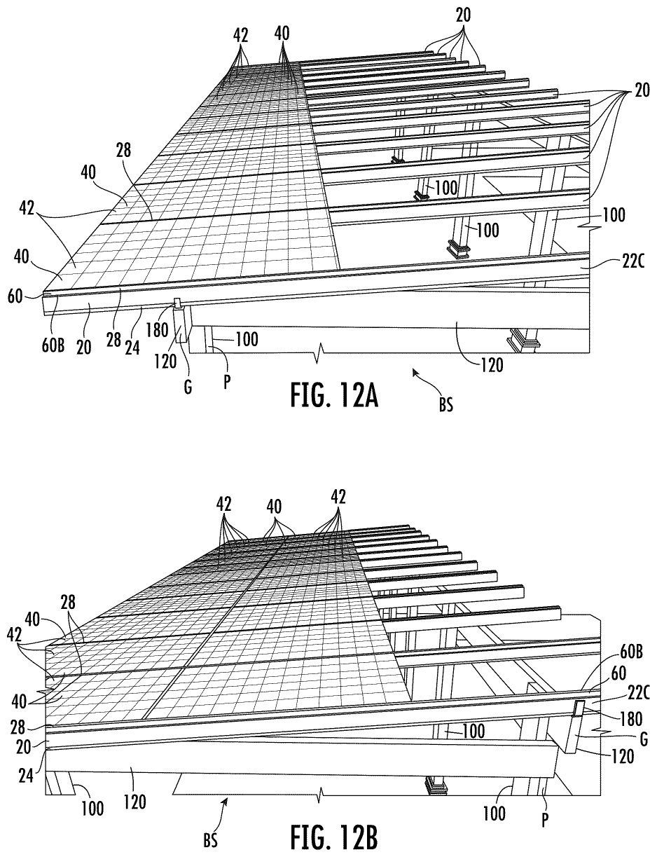

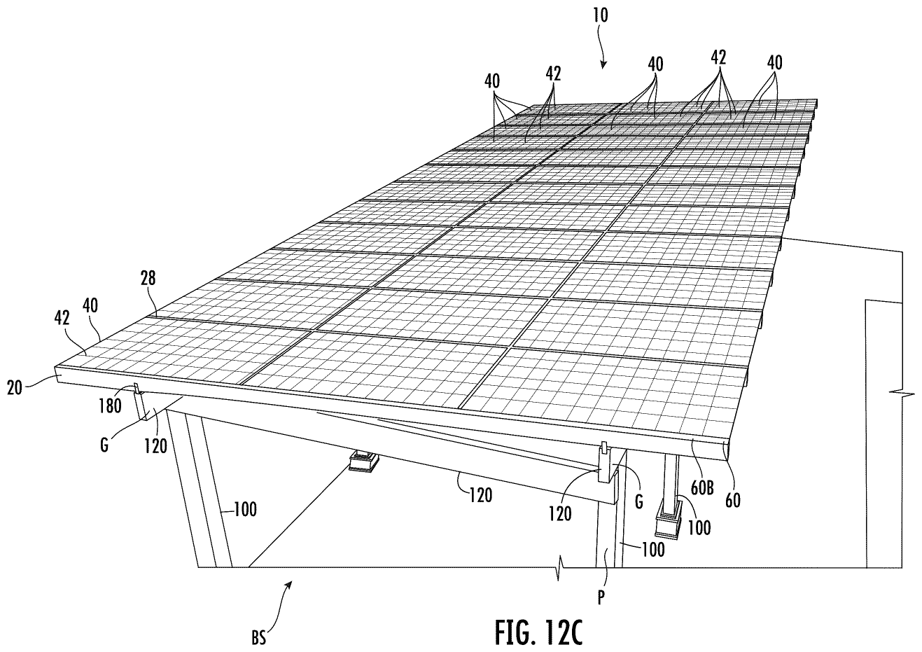

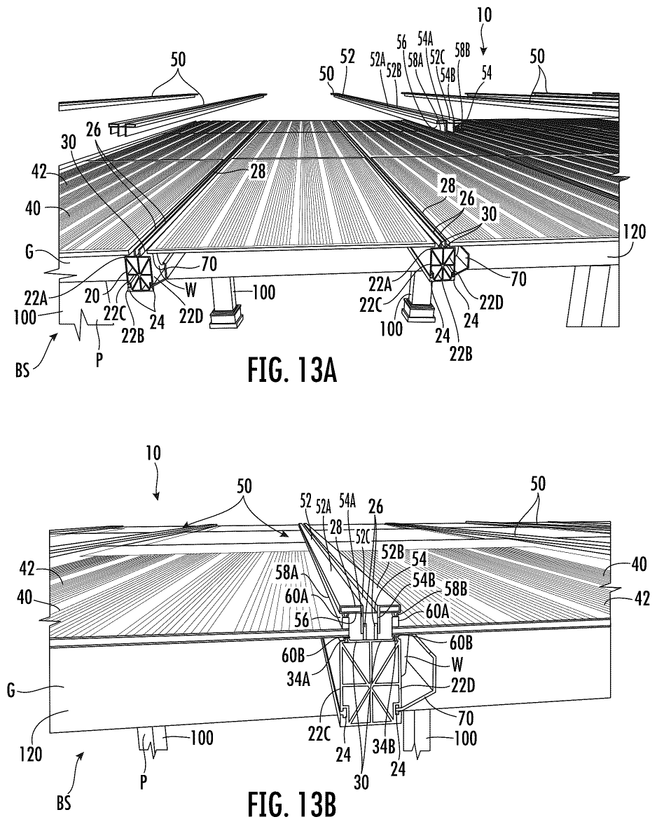

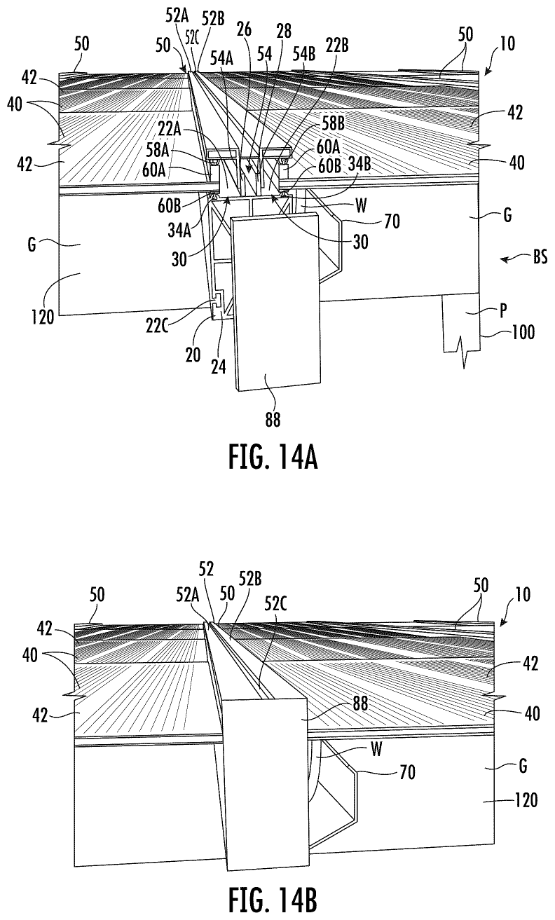

Referring to FIGS. 1A-15B, the structure system 10 is provided that can comprise a frame system 10A and a roofing system 10B that can include an array of components. The frame system 10A can include a plurality of post beams 100 as shown in FIGS. 1A-2, 4A, and 4C-4E and a plurality of frame beams 120 as shown in FIGS. 1A-2 and 4F-4H. In some embodiments, each of the post beams 100 can comprise one or more extruded aluminum structural beams. Each of the post beams 100 of the plurality of post beams 100 can have one or more post slots 102, such as two parallel slots as shown, along at least a first side wall 100A of the post beam 100. Each slot 102 can be a T-bolt slot. The frame system 10A can also include a plurality of post bases 130 as shown in FIGS. 1A-2 and 4B corresponding to the plurality of post beams 100. The frame system 10A of the structure system 10 can also comprise a plurality of frame beams 120. In some embodiments, each of the frame beams 120 can also comprise one or more extruded aluminum structural beams. Each of the frame beams 120 of the plurality of frame beams 120 can have one or more frame slots 122, such as two parallel slots as shown, along at least a first side wall 120A and a second side wall 120B of frame beam 120 as shown in FIGS. 4F-4H. Each slot 122 can be a T-bolt slot. The frame system 10A can also comprise a plurality of T-frames 140 as shown in FIGS. 1A-2 and 5A. Each T-frame 140 can be configured to extend upward from a top end 101A of a corresponding post beam 100 of the plurality of post beams 100. Each T-frame 140 can have a post receiving aperture 142 for receiving the top end 101A of the corresponding post beam 100 and a frame beam groove 144 positioned above the post receiving aperture 142 for receiving one or more frame beams 120 of the plurality of frame beams 120. Additionally, the frame system 10A can comprise a plurality of brackets 150, 160, 170, 180 as shown in FIGS. 3A-8C for securing corresponding post beams 100 of the plurality of post beams 100 and corresponding frame beams 120 of the plurality of frame beams 120 together.

Referring to FIGS. 4A and 4B, each of the post bases 130 can comprise side walls that can correspond to the number of sides walls of the post beams with which the post bases are used in conjunctions. For example, in some embodiments, the number of the post beam side walls, and thus the post base side walls can be 3, 4, 5, 6, or 8, for example. Referring to FIGS. 4A and 4B, each of the post bases 130 as shown can comprise four side walls 130A, 130B, 130C, 130D with an aperture 132 formed at a top 131A of the post base as shown in FIGS. 1A-2 and 4F for receiving a bottom end 101B of a corresponding post beam 100 of the plurality of post beams 100. The post base 130 can include a base shelf 134 extending from at least one of the four walls 130A, 130B, 130C, 130D of the post base 130 configured to support the bottom end 101B of the corresponding post beam 100. For example, as shown in FIG. 4B, in some embodiments, the post base 130 can include one or more shelves 134 that can extend from one or both of the opposing first wall 130A and second wall 130B. Further, post bases 130 can further comprise one or more base slots 136 that can be in at least side wall 130A of the post base 130 that can be aligned with the one or more post slots 102 in the first side wall 100A of the side walls 100A, 100B, 100C, 100D of the post beam 100. The one or more slots 136 can be elongated apertures that can receive portions of fasteners 137. For example, the fasteners 137 can comprise bolts, such as T-bolts that have been slid into the slots 102 of the post beams 100 and have nuts and or washers secured thereto. For example, in some embodiments, two base slots 136 can be in first side wall 130A of the post base 130 that can be aligned with the post slots 102 in the first side wall 100A of the post beam 100 and two base slots 136 can be in second side wall 130B of the post base 130 that can be aligned with the post slots 102 in the second side wall 100B of the post beam 100.

Additionally, each post base 130 of the plurality of post bas post bases 130 can comprise a bottom wall 131B that includes a first aperture 138A therein configured for receiving direct current (DC) wiring and a second aperture 138B therein configured for receiving alternating current (AC) wiring. Additionally, each post base of the plurality of post bases 130 can comprise a pair of securement slots 135 in the bottom wall for securing the post base to a surface.

Referring to FIGS. 1A-2, 4A, and 4C-4E, 4I and 4J, the post beams 100 of the frame system 10A can fit in and be secured to the post base 130 to form posts P of the building structure BS in the structure system 10. As stated above, each of the post beams 100 of the plurality of post beams 100 can have side walls. For example, in some embodiments, the number of the post beam side walls can vary by design. For example, some post beams have 3, 4, 5, 6, or 8 side walls, for example. Each of the post beams 100 of the plurality of post beams 100 can have one or more post slots 102 along at least a first side wall 100A of the post beam 100. For example, as stated above, each of the post beams 100 can also comprise one or more post slots 102 along a second side wall 100B of the post beam 100 opposite the first side wall 100A of the post beam 100. In some embodiments, the post slots 102 in the plurality of post beams 100 can comprise T-bolt slots configured to receive T-bolts for facilitating the securement of the plurality of post beams 100, the plurality of post bases 130, the plurality of frame beams 120, the plurality of T-frames 140 and plurality of brackets into a desired structure. In some embodiments as shown, there can be two parallel slots 102 in each of the first side wall 100A and the second side wall 100B. In some embodiments, each of the post beams 100 can comprise a first channel 104 configured for receiving direct current (DC) wiring and a second channel 106 configured for receiving alternating current (AC) wiring. As shown, in some embodiments, each of the first and second channels 104, 106 of the post beams 100 can comprise a channel that is enclosed on four sides with a cavity through the middle that is open on the top and bottom ends 101A, 101B of the respective post beam 100. The first and second channels 104, 106 of the post beams 100 can have a dividing wall 105 between the first and second channels 104, 106. The first and second apertures 138A, 138B of the post base 130 and the first and second channels 104, 106 of the post beams 100 can be of a size to receive one inch conduit for bringing the AC and DC wiring into the post P.

In some embodiments, the post beams can comprise a plurality of structural beams secured together to form a post beam 100′. For example, as shown in FIG. 4D, the post beam 100′ can comprise two outward facing structural beams 108′ and 112′. The structural beams 108′ and 112′ secured to each other to form the respective post beam 100′. The post beam 100′ can operate generally the same the post beam 100 that is of a unitary structural beam construction shown in FIG. 4C. The post beam 100′ shown in FIG. 4D can comprise one or more post slots 102′ along a first and second side wall 100A′, 100B′ of the post beam 100′. These post slots 102′ can be parallel to each other. Each of the post beams 100′ can comprise a first channel 104′ and a second channel 106′ that can comprise a channel that is enclosed on four sides with a cavity through that is open on the top and bottom ends 101A′, 101B′ of the respective post beam 100′. In some embodiments, each of the two structural beams 108′ and 112′ can have a front, or outward facing, side wall forming a side wall 100C′ or 100D′ of the post beam 100′. Each of the two structural beams 108′ and 112′ can also have a back side wall 116′ and 118′ of the respective structural beam 108′ and 112′. The back side wall 116′ and 118′ of the respective structural beam 108′ and 112′ are engaging walls that that can engage each other or other structural beams to facilitate forming the post beam. The back side walls 116′ and 118′ can each have a rail 110A′ and 114A′ and slot 110B′ and 114B′ that extend from a first end to a second end of the respective structural beam 108′ and 112′ on the back side wall 116′ and 118′. Additionally, each of the outward facing structural beams 108′ and 110′ can have first walls 109A, 113A and second side walls 109B, 113A each having one or more post slots 102′ therein. In the embodiment shown, the first walls 109A, 113A and second side walls 109B, 113A each having one post slot 102′ therein. In this manner, the rail 110A′ and the slot 110B′ of the first structural beam 108′ is configured to engage the slot 114B′ and the rail 114A′ of the second structural beam 112′ to form the post beam 100′ that comprises the two parallel post slot 102′ along the first side wall 100A′ of the post beam 100′ and two parallel post slots 102′ along a second side wall 100B′ opposite the first side wall 100A′ of the post beam 100′.

Referring to FIGS. 1A-2 and 4F-4H, the frame beams 120 of the frame system 10A can form girders G of the building structure BS in the structure system 10. As stated above, each of the frame beams 120 of the plurality of frame beams 120 can also have one or more frame slots 122 along at least a first side wall 120A of the frame beams 120. For example, as stated above, each of the frame beams 120 can also comprise one or more frame slots 122 along a second side wall 120B of the frame beams 120 opposite the first side wall 120A of the frame beams 120. The slots 122 along the first side wall 120A of the frame beams 120 can be parallel to each other and the slots 122 along the second side wall 120B of the frame beams 120 can be parallel to each other. In some embodiments, the frame slots 122 in the plurality of frame beams 120 can comprise T-bolt slots configured to receive T-bolts for facilitating the securement of the plurality of post beams 100, the plurality of post bases 130, the plurality of frame beams 120, the plurality of T-frames 140 and plurality of brackets into a desired structure. In some embodiments, each of the frame beams 120 can comprise a first channel 124 and a second channel 126. As shown, in some embodiments, each of the first and second channels 124, 126 of the frame beams 120 can comprise a channel that is enclosed on four sides with a cavity that is open on the top and bottom ends 121A, 121B of the respective frame beams 120. The first and second channels 124, 126 of the frame beam 120 can have a dividing wall 125 between the first and second channels 124, 126.

Similarly, in some embodiments, the frame beams 120 can comprise two structural beams secured together to form a frame beam 120′ as shown in FIG. 4G. Thus, each of the extruded aluminum structural beam of the frame beam 120′ can comprise two structural beams 128′ and 129′ secured to each other to form the respective frame beam 120′. The post beam 100′ can operate generally the same the post beam 100 that is of a unitary structural beam construction shown in FIG. 4C. The frame beam 120′ shown in FIG. 4D can comprise one or more frame slots 122′ along a first and second side wall 120A′, 120B′ of the frame beam 120′. Each of the frame beam 120′ can comprise a first channel 124′ and a second channel 126′ that can comprise a channel that is enclosed on four sides with a cavity through the middle that is open on the top and bottom ends 121A′, 121B′ of the respective frame beam 120′. In some embodiments, each of the two structural beams 128′ and 129′ can have a front side wall forming a side wall 120C′ or 120D′ of the frame beam 120′. Each of the two structural beams 128′ and 129′ can also have a back side wall 128C′ and 129C′ of the respective structural beam 128′ and 129′. The back side walls 128C′ and 129C′ can each have a rail 128A′ and 129A′ and slot 128B′ and 129B′ that extend from a first end to a second end of the respective structural beam 128′ and 129′ on the back side wall 128C′ and 129C′. Additionally, each of the two structural beams 128′ and 129′ can have first and second side walls each having one or more frame slots 122′ therein. In the embodiment shown, the first and second side walls of the two structural beams 128′ and 129′ each have one frame slot 122′ therein. In this manner, the rail 128A′ and the slot 128B′ of a first structural beam 128′ is configured to engage a slot 129B′ and a rail 129A′ of a second structural beam 129′ to form a frame beam 120′ that comprises the two parallel frame slot 122′ along the first side wall 120A′ of the frame beam 120′ and two parallel post slots 122′along a second side wall 120B′ opposite the first side wall 120A′ of the frame beam 120′.

Referring to FIGS. 4I and 4J, as stated above, the post beams and frame beams can comprise multiple structural beams. As shown in FIGS. 4I and 4J, a center structural beam 210 can be provided that can be used between outward facing structural beams 108′, 112′ as shown in FIG. 4D and described above to form a post beam 220. The outward facing structural beams 108′ and 112′ secured to one or more center structural beam 210 to form a post beam, such as the respective post beam 220 as shown in FIG. 4J. The post beam 220 can operate generally the same the post beams 100 and 100′ described above. As in the embodiment shown in FIG. 4J, the post beam 220 can comprise three post slots 102 along a first and second side wall 100A′, 100B′ of the post beam 220.

In some embodiments as shown in FIG. 4I, the center structural beam 210 can comprise a first side wall 214A and an opposing second wall 214B. The first and second side walls 214A and 214B of the center structural beam 210 are engaging walls that that can engage each other or other structural beams to facilitate forming the post beam. Additionally, the center structural beam 210 can have a third side wall 214C and an opposing fourth side wall 214D. In some embodiments, as shown, the third and fourth side walls 214C, 214D can each having a post slot 102 therein. In some embodiments, as shown, the third and fourth side walls 214C, 214D may not have any post slots therein. Each of the center structural beam 210 can comprise a channel 219 that can comprise a channel that is enclosed on four sides with a cavity through the middle that is open on the top and bottom ends (not shown) of the respective center structural beam 210. Each of the first and second side walls 214A and 214B can comprise a rail 216A, 218A and a slot 216B, 218B that extend from a first end of the respective center structural beam 210 to a second end of the respective center structural beam 210. The rails 216A, 218A and slots 216B, 218B on the first and second side walls 214A and 214B of each center structural beam 210 are configured to engage the rails 110A′, 114A′ and slot 110B′, 114B′ of a first outward facing structural beam 108′, a second outward facing structural beam 112′, or another center structural beam 210. The rails 216A, 218A and the slots 216B, 218B can be offset on each side wall 214A, 214B such that the rail 216A on the first side wall 214A is aligned with the slot 218B on the opposing second side wall 214B and the rail 218A on the second side wall 214B is aligned with the slot 216B on the opposing first side wall 214A. This configuration allows either side wall 214A and 214B of a center beam 210 to engage another center structural beam 210 or an outward facing structural beam 108′ and 112′. Thus, the size of the post beam 220 can be adjusted to meet the needs of the user. Some post beams with connected structural beams can be two outward facing structural beams. Some post beams can comprise two outward facing structural beams with one or more center structural beams therebetween to add strength and girth. While the use of center beams is described with reference to post beams, similar center structural beams can also be used in conjunction with outward facing frame structural beams 128′, 129′ to form different sized frame beams, if desired.

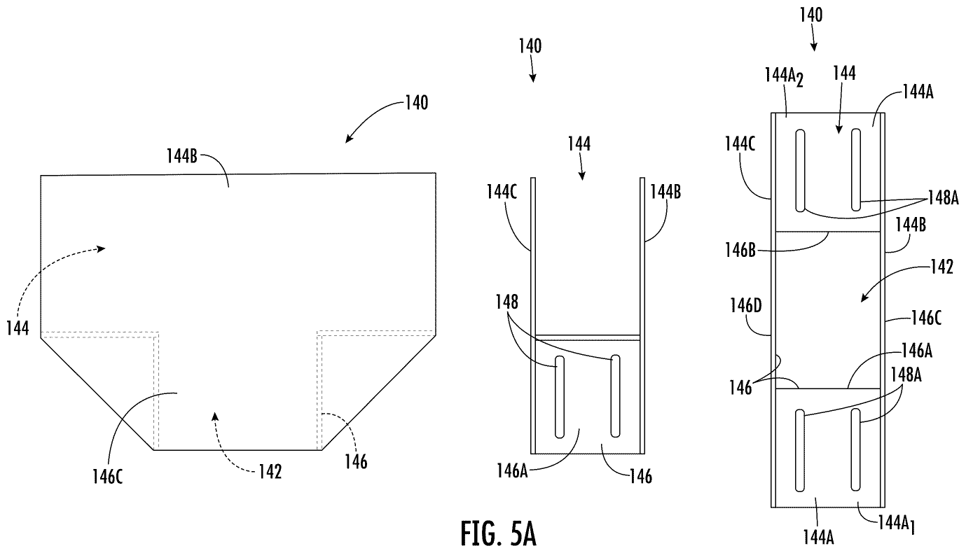

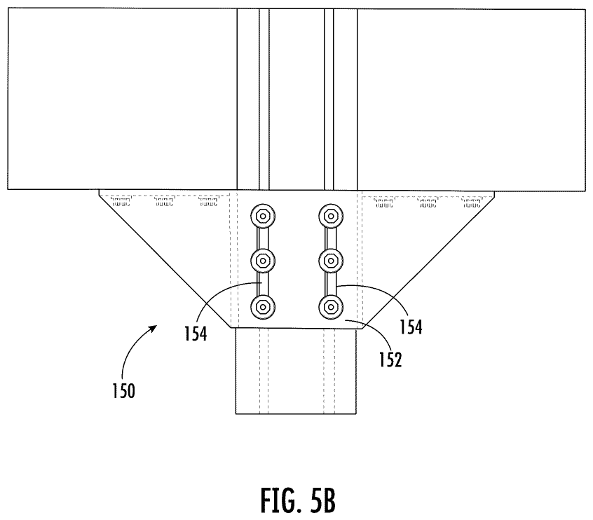

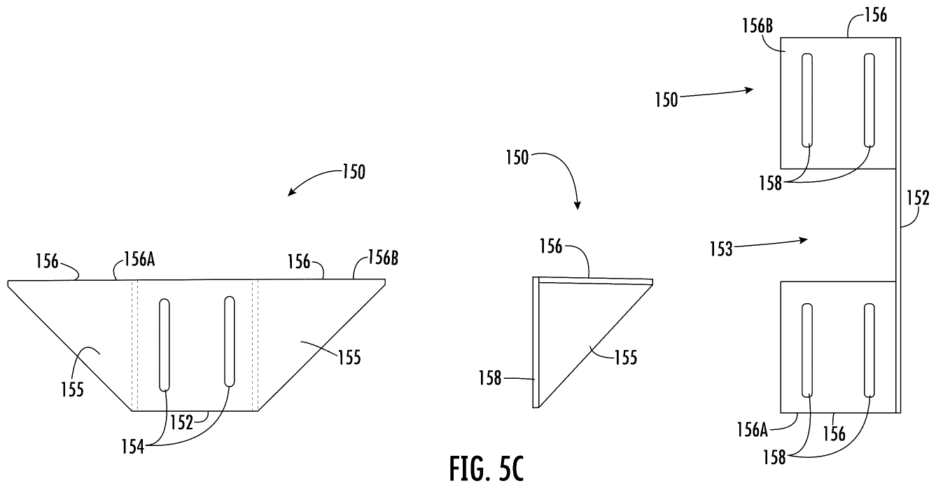

As stated above, each T-frame 140 of the plurality of T-frames 140 can have a post receiving aperture 142 for receiving the top end 101A of a corresponding post beam 100 and a frame beam groove 144 positioned above the post receiving aperture 142 for receiving one or more frame beams 120 of the plurality of frame beams 120. Referring to FIG. 5A, each T-frame 140 of the plurality of T-frames 140 can comprise a post sleeve 146 in which the post receiving aperture 142 resides. The post sleeve 146 can comprise side walls. In particular, the number of side walls of the post sleeve 146 can correspond to the number of side walls of the post beams on which the post sleeve 146 are used. For example, as shown, in some embodiments where the post beams have four side walls, the post sleeve 146 can comprise side walls 146A, 146B, 146C, 146D with a first side wall 146A of the side walls having one or more slots 148 therein. For example, the one or more slots 148 can comprise two parallel slots 148 of the post sleeve 146 can be aligned with the post slots 102 in the first side wall 100A of the side walls 100A, 100B, 100C, 100D of the respective post beam 100 to secure the T-frame 140 to a respective post beam 100 of the plurality of post beams 100. As above, in some embodiments, a second side wall 146A of the side walls 146A, 146B, 146C, 146D of the post sleeve 146 can have one or more slots 148, such as two parallel slots as shown, therein can be aligned with the post slots 102 in the second side wall 100B of the respective post beam 100 to secure the T-frame 140 to a respective post beam 100. The slots 148 can be apertures for receiving portions of T-bolts inserted in the post slots 102 of the post beams 100.

As shown in FIG. 5A, the frame beam groove 144 can extend above the post sleeve 146 of each T-frame 140. The frame beam groove 144 in the T-frame 140 can comprise a bottom groove wall 144A as well as a first side wall 144B and a second side wall 144C extending upward from opposing sides of the bottom groove wall 144A. The bottom groove wall 144A of the frame beam groove 144 can comprise one or more slots 148A therein. For example, the bottom groove wall 144A of the frame beam groove 144 can comprise two parallel slots 164 therein that can be aligned with the one or more frame slots 122 in the first side wall 120A of a frame beam 120 to secure the T-frame 140 to a respective frame beam 120 of the plurality of frame beams 120. The slots 148A can be apertures for receiving portions of T-bolts inserted in the frame slots 122 of the frame beams 120. In some embodiments as shown, the bottom groove wall 144A of the frame beam groove 144 can comprise a first bottom groove 144A₁ wall that can extend from a top of the post sleeve 146 perpendicular to the first wall 146A of the side walls of the post sleeve 146 and a second bottom groove wall 144A₂ that extends from a top of the post sleeve 146 perpendicular to the second wall 146B of the side walls of the post sleeve 146. The first bottom groove wall 144A₁ can have one or more slots 148A, such as two parallel slots as shown, therein that can be aligned with frame slots 122 in the first side wall 120A of one or more frame beams 120 to secure the T-frame 140 to one or more respective frame beams 120. Similarly, the second bottom groove wall 144A₂ can have one or more slots 148A, such as two parallel slots as shown, therein that can be aligned with frame slots 122 in the first side wall 120A of one or more frame beams 120 to secure the T-frame 140 to the one or more respective frame beams 120. In some embodiments, the first and second sidewalls 144B, 144C of the frame beam groove 144 of the T-frame 140 can be contiguous with a third wall 146C and fourth wall 146D of the side walls of the post sleeve 146 of the T-frame 140 as seen in FIG. 5A. T-frame 140 can have a cut out on one side for mounting of a NS brace bracket 160 (described below) where the NS brace bracket 160 lines up on a central post beam 100.

As stated above, a plurality of different brackets 150, 160, 170 for securing corresponding post beams 100 of the plurality of post beams 100 and corresponding frame beams 120 of the plurality of frame beams 120 together. Shown in FIGS. 5B-7C, NS T-brackets 150, NS Left (L) and Right (R) brace brackets 160, and L-brackets 170 are provided. As shown in FIGS. 5B and 5C, a NS T-bracket 150 is provided that can comprise a bracket body 152 with one or more flanges 156 extending from the bracket body 152. The bracket body 152 can extend in a first plane and the first flange 156 can extend from the bracket body 152 in a second plane perpendicular to the first plane. For the NS T-bracket 150, the one or more flanges 156 can be a first flange 156A and a second flange 156B to support two different frame beams 120 on either side of a post beam 100. For example, as shown in FIGS. 5B and 5C, a NS T-bracket 150 is provided that can comprise a bracket body 152 with a first flange 156 extending from the bracket body 152. The bracket body 152 can extend in a first plane and the first flange 156 can extend from the bracket body 152 in a second plane perpendicular to the first plane. NS T-bracket 150 can comprise a second flange 156B that extends from the bracket body 152 in the second plane perpendicular to the first plane. Webbing 155 can be provided to provide extra support and strength between bracket body 152 and first and second flanges 156A, 156B. The first flange 156A and second flange 156B can create a space 153 for receiving the post beam 100 therein. The bracket body 152 of the NS T-bracket 150 can comprise one or more slots 154 therein. For example, the bracket body 152 of the NS T-bracket 150 can comprise one or more slots 154, such as two parallel slots as shown, that can be aligned with post slots 102 in the first side wall 100A of a post beam 100 of the plurality of post beams 100. The first and second flanges 156A, 156B also can each have one or more slots 158, such as two parallel slots as shown, therein that can be aligned with frame slots 122 in the first side wall 120A of two different frame beams 120 of the plurality of frame beams 120 to secure the post beam 100 and frame beams 120 together.

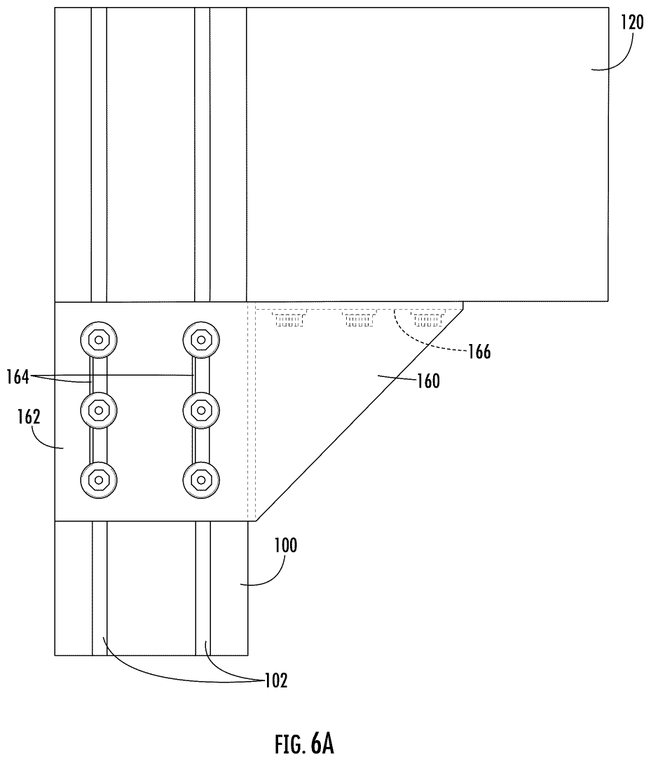

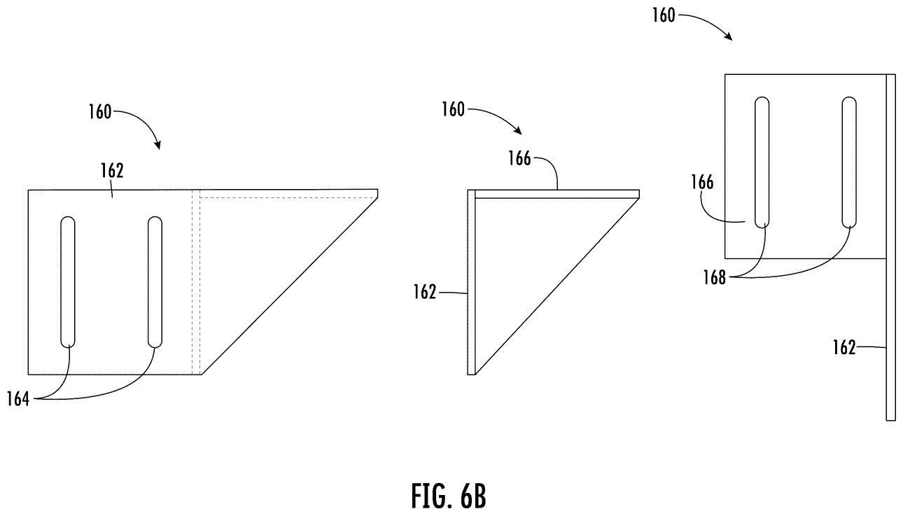

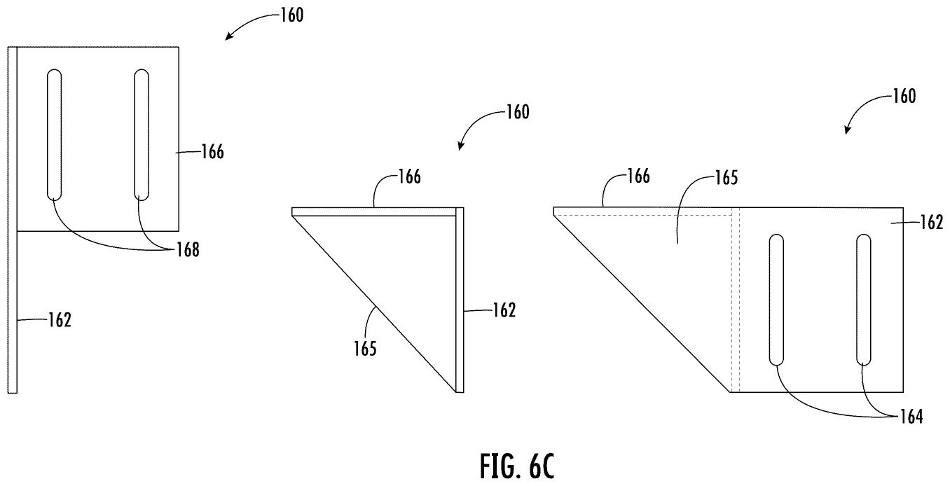

As shown in FIGS. 6A-6C, NS right and left brackets 160 is provided. Each bracket 160 can comprise a bracket body 162 with a first flange 166 extending from the bracket body 162. The bracket body 162 can extend in a first plane and the first flange 166 can extend from the bracket body 162 in a second plane perpendicular to the first plane. The bracket body 162 of the NS right or left bracket 160 can comprise one or more slots 164 therein. For example, the bracket body 162 of the NS right or left bracket 160 can comprise two parallel slots 164 therein that can be aligned with post slots 102 in the first side wall 100A of a post beam 100 of the plurality of post beams 100. Similarly, the first flange 166 can have one or more slots 168, such as two parallel slots as shown, therein that can be aligned with frame slots 122 in the first side wall 120A of a frame beam 120 of the plurality of frame beams 120 to secure the post beam 100 and frame beam 120 together. Webbing 165 can be provided to provide extra support and strength between bracket body 162 and flanges 166. NS Bracket 160 have a left and right configuration for holding the North to South brace (front to back of structure). NS Brackets 160 can be configured to join the side wall of the frame beam 120 to the end of a frame beam 120 turned 90 degrees and perpendicular to the post beam 100.

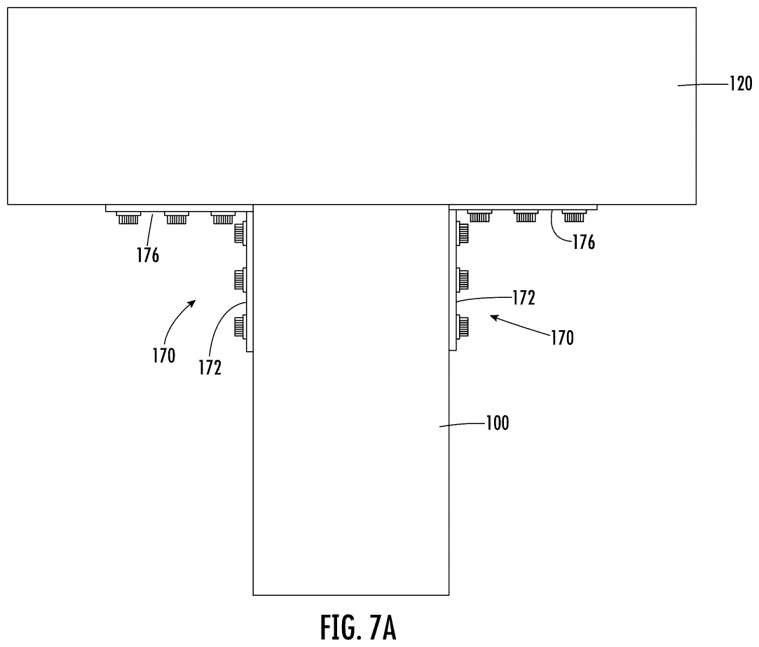

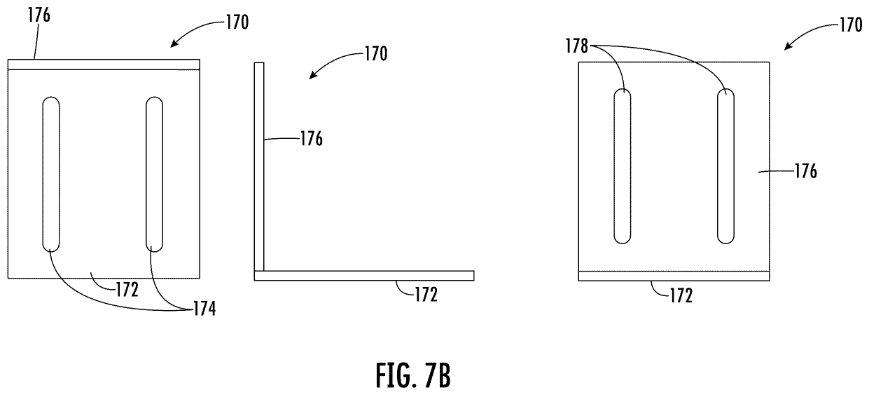

As shown in FIGS. 7A and 7B, L-brackets 170 is provided. Each bracket 170 can comprise a bracket body 172 with a first flange 176 extending from the bracket body 172. The bracket body 172 can extend in a first plane and the first flange 176 can extend from the bracket body 172 in a second plane perpendicular to the first plane. The bracket body 172 of the L-bracket 170 can comprise one or more slots 174, such as two parallel slots as shown, therein that can be aligned with post slots 102 in the first side wall 100A of a post beam 100 of the plurality of post beams 100. Similarly, the first flange 176 can have one or more slots 178, such as two parallel slots as shown, therein that can be aligned with frame slots 122 in the first side wall 120A of a frame beam 120 of the plurality of frame beams 120 to secure the post beam 100 and frame beam 120 together.

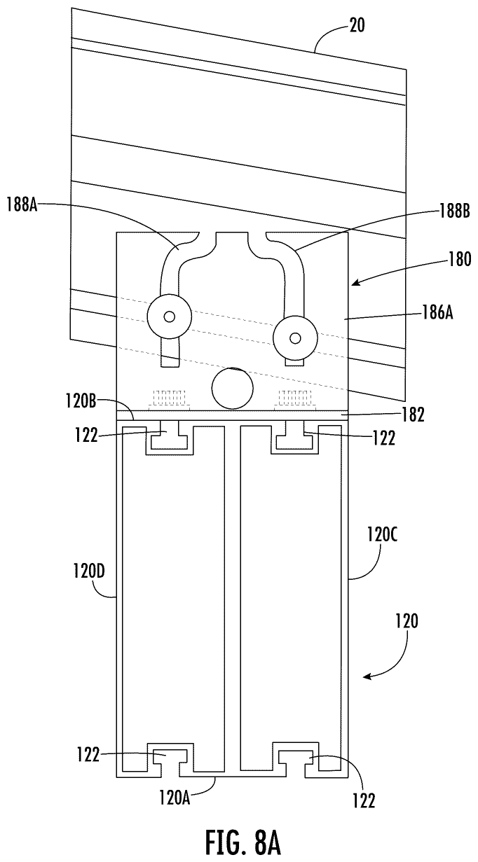

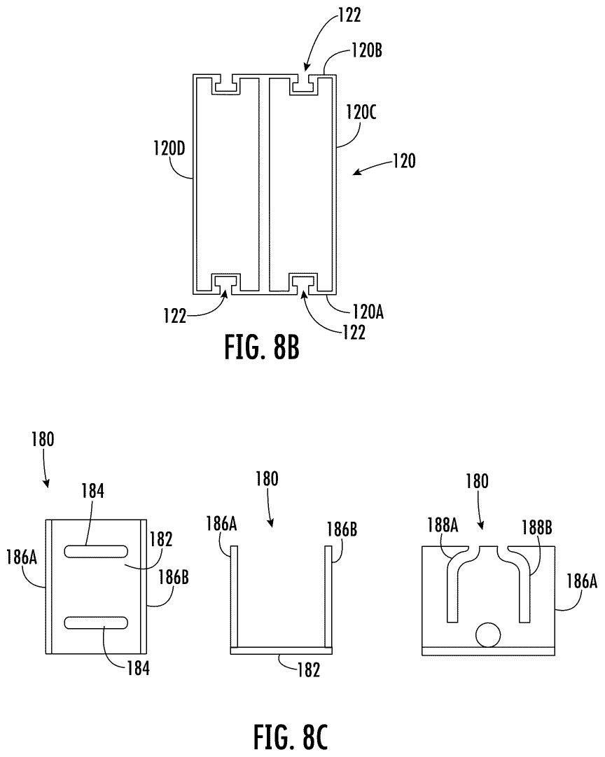

Referring to FIGS. 3A-3B and 8A-8C, a plurality of U brackets 180 can be provided that can be used to secure rafter beams 20 for a roofing system 10B to the frame system 10A formed by the post beams 100 and the frame beams 120. Each U-bracket 180 can comprise a bottom wall 182 having one or more slots 184, such as two parallel slots as shown, therein that can be aligned with frame slots 122 in the second side wall 120B of a frame beam 120 of the plurality of frame beams 120 for securing the U bracket 180 to the respective frame beam 120. The U bracket 180 can also comprise a first side wall 186A and a second side wall 186B that extend upward from opposing sides of the bottom wall 182 of the U bracket 180. The first and second side walls 186A, 186B and bottom wall 182 can form an open channel 185 for receiving a rafter beam 20 of the plurality of rafter beams 20 for securing the rafter beam 20 to the frame beam 120. The first side wall 186A of the U-bracket 180 can comprise a first curved slot 188A and a second curved slot 188B that can extend through a top end 186A₁ of the first side wall 186A of the U-bracket 180 with the first and second slots 188A, 188B curving toward each other at top portions of the first and second curved slots 188A, 188B. Similarly, the second side wall 186B of the U-bracket 180 can comprise a first curved slot 188A and a second curved slot 188B that can extend through a top end 186B₁ of the second side wall 186B of the U-bracket 180 with the first and second slots 188A, 188B curving toward each other at top portions of the first and second curved slots 188A, 188B. The shape of the first and second curved slots 188A, 188B of the first and second side walls 186A, 186B help to hold the rafter beam in place. The use of T-bolts in slots of the rafter beam 20 and the shape of the first and second curved slots 188A, 188B make installation much easier, while providing a strong hold between the rafter beam 20 and the U-bracket 180 and frame beam 120. In particular, the first and second curved slots 188A, 188B in the first and second side walls 186A, 186B of the U bracket 180 are transverse to T-bolt slots in the respective rafter beam 20 placed in the channel of the U bracket 180. The U bracket 180 can have an opening therein to receive ¾″ conduit that can be run along the top of the framing system under the rafter beams 20 to facilitate wiring.

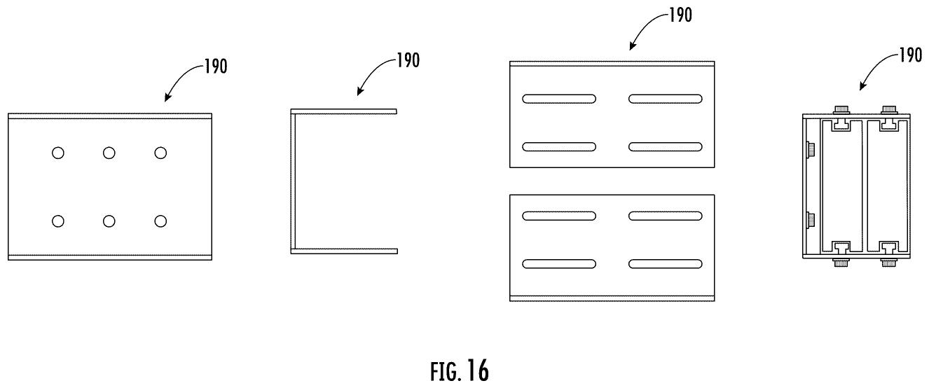

Referring to FIG. 16, a wall bracket 190 can be provide that is configured to be secured to another structure and to a post beam of the plurality of post beams. The wall bracket 190 has a first side wall that has one or more securement apertures for receiving fasteners for securement to a structure. The wall bracket 190 can comprise second and third side walls that extend from the first side wall. The second and third side walls each can have one or more slots, such as two parallel slots as shown, therein. The one or more slots in the second side wall of the wall bracket 190 can be aligned with the one or more post slots 102 in the first side wall 100A of a post beam 100 of the plurality of post beams 100. Similarly, the one or more slots in the third side wall of the wall bracket 190 can be aligned with one or more post slots 102 along the second side wall 100B of the post beam 100 opposite the first side wall 100A of the post beam 100.

Once a frame structure, or building structure BS, is assembled from the frame system 10A, roofing system 10B of the structure system 10 can be assembled and secured to the frame structure. Referring to FIGS. 1A, 1B, and 9A-15B, the roofing system 10B can include rafter beams 20 and roofing panels 40 that can be manufactured in a variety of sizes to support a range of spans. The roofing system 10B incorporates top caps 50 and gaskets 60 such that the rafter beams 20 receives the top caps 50 with the gaskets 60 securing and holding the roofing panels 40 between the structural beams 20 and the top caps 50. The roofing system 10B with the structural beams 20, the top caps 50, and the gaskets 60 can be used to support roofing panels 40 that can be either solar panels, i.e., solar modules, 42 or insulated roofing panels, i.e., weatherproof roofing panels, 44 to create a completely watertight structure. The gaskets 60 can comprise adhesive flat gaskets that adhere between the modules along the long edge where it does not rest on the structure framing system to make a watertight seal.

When the roofing system 10B is used as a roofing structure, the insulated panels 44 (as shown in FIG. 1B) can be sandwiched between the rubber gaskets 60 positioned on the top caps 50 and the beams 20. The rafter beams 20 that can be attached to frame beams 120 as described above and can function as rafters and the insulated roof panels 44 function as sheathing and roofing material. Each of the rafter beams 20 can include an interior gutter 30 that captures any moisture that may get past the gaskets 60 serving as a safety net for the watertight seal. That water would then run through an inside gutter channel 30 within the respective rafter beam 20 and come out the end outside of the underlying structure maintaining its watertight seal.

When used to create a solar integrated roofing structure, the solar modules 42 can be similarly sandwiched between the rubber gaskets 60 positioned on the top caps 50 and the beams 20. A sealant can be used between the solar modules. For example, a double-sided butyl tape can be placed in between the overlap to seal the overlapping solar modules 42 to along the overlap. Unlike conventional solar racking structures commonly used, this tape is not exposed to the elements and therefore does not have a limited lifespan. The same or similar sealants can be used between insulated roofing panels 44. The solar modules 42 can then be bonded to the bonding rail on the beam using a bonding jumper to create an obvious visible bond between the solar modules 42 and the respective rafter beam 20. This bonding is required in a solar installation due to the electrical components. A wire trough 70 can be slid into the respective rafter beam 20 for wire management and/or micro-inverter/optimizer mounting to hide and protect wiring in between the solar modules 42. This application contains the same gutter structure 30 as the roofing structure using insulated roofing panels applications.

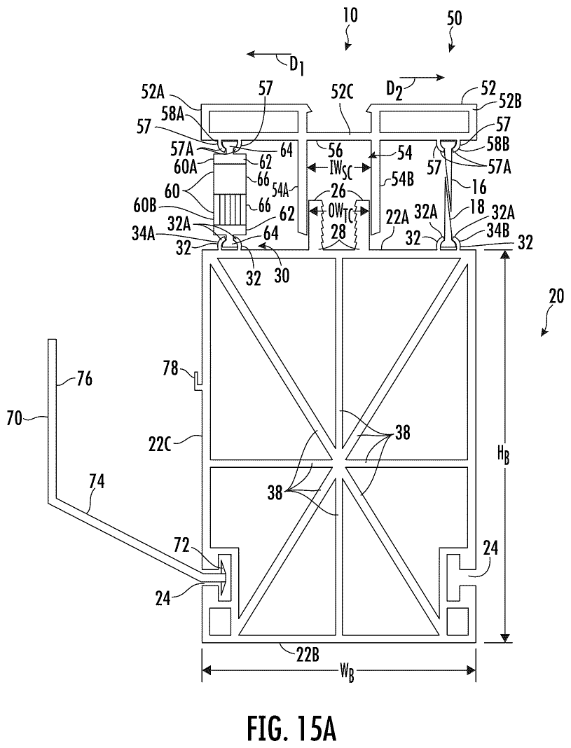

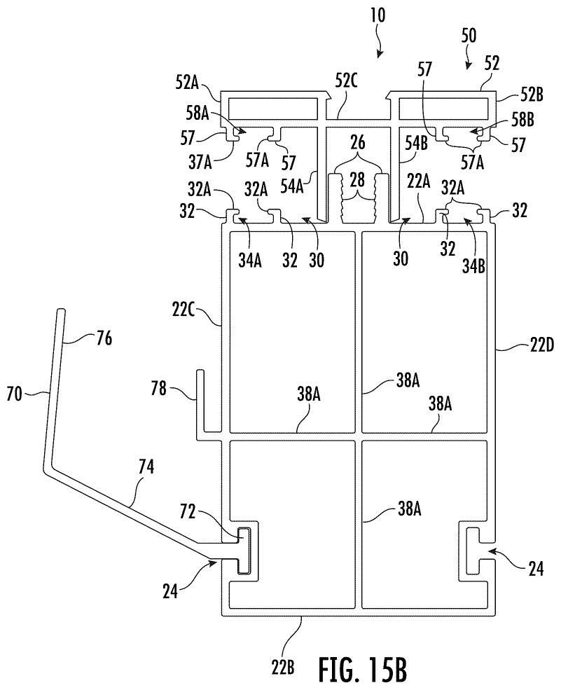

An exemplary embodiment of the roofing system 10B as shown in FIGS. 1A, 1B, and 9A-15B will now be described in more detail. The roofing system 10B can comprise two or more, or a plurality of, rafter beams 20 with each of the rafter beams 20 comprising an extruded structural beam. The rafter beams 20 can comprise a metal. For example, the structural beams 20 can comprise extruded aluminum. As shown in FIGS. 15A-15B, each rafter beam 20 can comprise a top wall 22A and a bottom wall 22B and two opposing side walls 22C, 22D. The rafter beam 20 can comes in various dimensions depending on the building structure with which it will be used. For example, for standard solar mounting applications with maximum span of about 6 ft., the cross-sectional dimensions of the beam 20 can be about 3.5 inches in width W_{B} by about 3 inches in height H_{B}. For spans up to about 12 ft., the cross-sectional dimensions of the beam 20 can be about 3.5 inches in width W_{B} by about 6 inches in height H_{B}. For spans up to about 16 ft., the cross-sectional dimensions of the beam 20 can be about 3.5 inches in width W_{B} by about 8 inches in height H_{B}. For spans up to about 18 ft., the cross-sectional dimensions of the beam 20 can be about 3.5 inches in width W_{B} by about 10 inches in height H_{B}. The thickness of the top wall 22A, the bottom wall 22B, and two opposing side walls 22C, 22D may vary as well, depending on the length of the span of the rafter beam 20. Additionally, the rafter beam 20 can include reinforcement support tabs 38, 38A within an interior of the rafter beam 20 that can be provided at different angles to provide increased structural integrity and support to the rafter beam 20 to help withstand the different types of stresses and forces placed on the beams 20. For example, as shown in FIG. 15A, the support tabs 38 within the interior of the rafter beam 20 can include support tabs 38 that run at acute angles to the walls 22A, 22B, 22C and 22D of the rafter beam 20 as well as support tabs 38 that are about perpendicular, or normal, to the respective walls 22A, 22B, 22C and 22D of the rafter beam 20 from which they extend to provide increased structural integrity and support to the rafter beam 20. In some embodiments, as shown in FIG. 15B, the support tabs 38A within the interior of the rafter beam 20 may include only support tabs 38 that are about perpendicular, or normal, to the respective walls 22A, 22B, 22C and 22D of the rafter beam 20 from which they extend to provide increased structural integrity and support to the rafter beam 20.

T-bolt slots 24 can be formed in at least one of the side walls 22C, 22D of each extruded beam 20 of receiving accessory attachments. For example, the T-bolt slots 24 can be used for attaching a wire trough 70 and/or for inserting bolts 82 into the respective rafter beam 20 for attachment of structural attachment brackets 80 for securing the respective structural beam to a building structure BS being roofed. In some embodiments, brackets having a T-shaped engagement can be slid into the T-bolt slots 24 for securing the respective structural beam to a building structure BS being roofed. The T-bolt slots 24 in each of the structural beams 20 can be formed in the respective rafter beam 20 during extrusion of the respective rafter beam 20.

Additionally, the T-bolt slot channels 24 positioned proximate to the bottom 22B of the structural beams 20 can be used to install a bottom cap (not shown). This makes it easy to insulate the spaces between the structural beams 20 for a higher R-Value when used in general construction or building integrated photo-voltaics (“BIPV”) applications and it is enclosed with a covering.

Each rafter beam 20 can also comprise channel walls 26 that can extend upward from the top wall 22A of the extruded beam 20. The channel walls 26 can form a threaded channel 28 for securing a respective top cap 50 to the respective rafter beam 20. The threaded channel 28 on the top portion, i.e., the top wall 22A of the respective rafter beam 20 can be formed as an integral part of the respective rafter beam 20 during the extrusion process.

Additionally, as shown in FIGS. 15A and 15B, each rafter beam 20 can comprise gasket channel walls 32 extending upward from the top wall 22A of the extruded beam 20. The gasket channel walls 32 form one or more gasket attachment channels 34A, 34B for securing gaskets 60 to the extruded beam 20. Thereby, each rafter beam 20 can be used to secure a bottom gasket 60B of the gaskets 60 such that the bottom gasket 60B can form a seal between the roofing panels 40 and the respective rafter beam 20 when the components are installed in the roofing system 10. As in the embodiment shown in FIGS. 15A and 15B, the rafter beam 20 can have a first gasket attachment channel 34A on a first side of the top wall 22A of the rafter beam 20 and a second gasket attachment channel 34B on a second side of the top wall 22A of the rafter beam 20 to accommodate bottom gaskets 60B for securement of roofing panels 40 on either side of the rafter beam 20. Depending on where the rafter beam 20 is used in the roofing system 10, for example, if the rafter beam 20 is a beam that forms an end edge of the roofing system 10, the gasket attachment channel 34A, 34B that forms the outer gasket attachment channel can be used for securing one of the end fins 18 to the respective rafter beam 20. Each of the gasket attachment channels 34A, 34B of the respective rafter beam 20 can be formed as an integral part of the respective rafter beam 20 during the extrusion process. As shown in FIGS. 15A and 15B, the gasket channel walls 32 can have lips 32A that extend farther inward into the channel than the base of the gasket channel walls 32 such that the base of the respective gasket attachment channel 34A, 34B is wider than its entrance. This configuration of the gasket attachment channels 34A, 34B create a holding mechanism for securing bottom gaskets 60B or end fins 18 to the rafter beam 20 with an easy-to-use sliding engagement.

Each rafter beam 20 can also comprise one or more interior gutters 30 built into the rafter beam 20 to drain any water that may leak between the gaskets 60 and the roofing panels 40 of the roofing system 10B. In particular, the interior gutters 30 can be formed along the top wall 22A of the extruded beam 20. In some embodiments, for example, two interior gutters 30 can be formed on either side of the threaded channel 28 between channel walls 26 that form the threaded channel 28 extending upward from the top wall 22A and gasket channel walls 32 that form one or more gasket attachment channels 34A, 34B also extending upward from the top wall 22A. The channel walls 26 of the thread channel 28 and the channel walls 32 of the gasket attachment channels 34A, 34B on rafter beam 20 with either a gasket 60 or an end fin 12 therein can thereby forms side walls of the one or more interior gutters 30.

As disclosed above for embodiments of the roofing system 10B that are a solar integrated roofing structure, the roofing system 10B can also comprise wire troughs 70 configured to accommodate wiring for solar modules 42 used as roofing panels. Each wire trough, or wire trough attachment, 70 can be attached to a side wall 22C, 22D of the rafter beam 20. As explained above, in some embodiments, a wire trough attachment 70 can be configured to engage a T-bolt slot 24 in a side wall 22C, 22D of rafter beam 20. The wire trough 70 is configured to accommodate wiring for solar modules 42 used as roofing panels 40 in conjunction with the rafter beam 20 to form the roofing system 10. For example, referring to FIGS. 15A and 15B, the wire trough 70 can be slid into a T-bolt slot 24 formed in the rafter beam 20. In such embodiments, each wire trough 70 can include a T-shaped base 72 that is configured to fit into one of the T-bolt slots 34 formed in a side wall 22C, 22D of the rafter beam 20 to firmly hold the respective wire trough 70 in place on the rafter beam 20. Each wire trough 70 can also comprise a trough body 74 that extends out from the T-shaped base 72. In some embodiments, the body 74 of the wire trough 70 can form the cavity of the trough between a wall 76 of the body 74 of the wire trough 70 and the side wall 22C, 22D of rafter beam 20 to which the wire trough 70 is secured.

Each rafter beam 20 can also comprise a bonding rail 78 as shown in FIGS. 15A and 15B, for example. The bonding rail 78 can extend outward from one of the side walls 22C, 22D of the extruded beam 20 above a T-bolt slot 24 in a side wall 22C, 22D of rafter beam 20. In some embodiments, the bonding rail 78 can be formed as an integral part of the extruded beam 20 during the extrusion process. For example, the bonding rail 78 can be on a side of a side wall 22C, 22D of rafter beam 20 to which the wire trough 70 is attached. In this manner, a standard UL listed bonding jumper can be attached or clipped to the bonding rail 78 between solar module 42 and rafter beam 20. Similarly, optimizers and/or microinverters can be attached or clipped to the bonding rail 78 in same way with the wire trough 70 hiding the wiring and microinverters and/or optimizers.

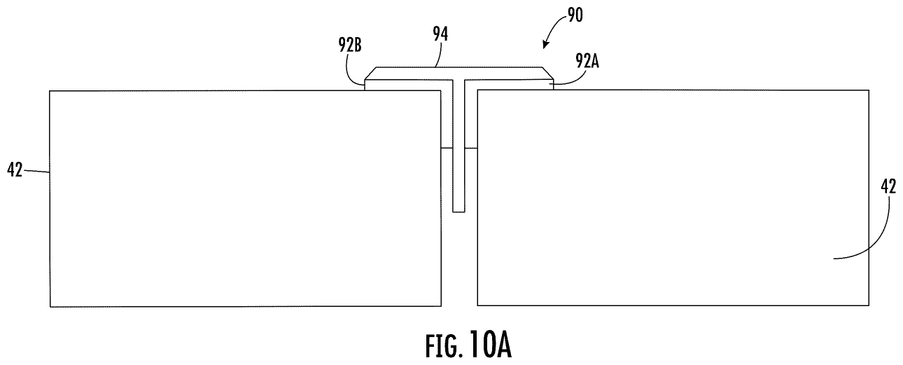

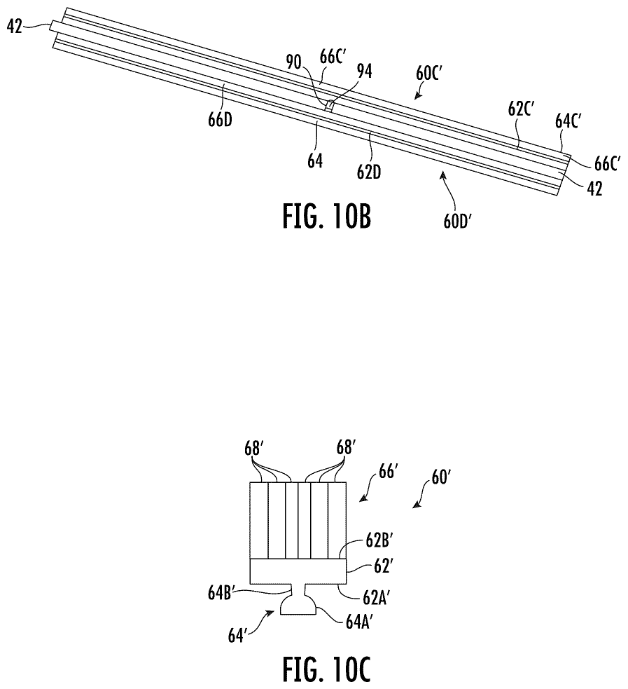

The roofing system 10B can comprise roofing panels 40 as shown in FIGS. 10A-10B and 12A-14B. The roofing panels 40 can comprise at least one of insulated roofing panels 44 or solar modules 42. When the roofing panels 40 comprise solar modules 42, the structural beams 20, the top caps 50 and the gaskets 60 form an integrated solar racking system that forms a roof of a structure.

The roofing system 10B can also comprise top caps 50 corresponding to the number of the one or more structural beams as shown in FIGS. 10A and 13A-15B. The top caps 50 can comprise a metal. For example, the top caps 50 can comprise extruded aluminum. The top caps 50 can be configured to secure the roofing panels 40 in place on the structural beams 20. The top caps 50 can have one or more gasket attachment channels 58A, 58B for securing top gaskets 60A of the gaskets 60 for forming a seal between the roofing panels 40 and the respective top cap 50.

In some embodiments, each top cap 50 can comprise a top portion 52 that includes a first flange 52A extending in a first direction D₁ and a second flange 52B extending in an opposing second direction D₂ with a securement indention 52C between the first and second flange 52A, 52B for receiving a fastener therein to engage the threaded channel 28 of the rafter beam 20. Each top cap 50 can comprise a securement positioning channel 54 that extends from a bottom portion 56 of the top cap 50.

The securement positioning channel 54 can align with the securement indention 52C between the first and second flanges 52A, 52B and can have securement channel walls 54A, 54B that extend from the bottom portion 56 of the top cap 50 to form the securement positioning channel 54. In some embodiments, the securement channel walls 54A, 54B can be separated by a distance such that the securement positioning channel 54 has an inner width IW_{SC} as measured from the inner surfaces of the securement channel walls 54A, 54B that is slight wider than the outer width OW_{TC} of the threaded channel 28 as measured from the outer surfaces of the channel walls 26 of the threaded channel 28. Thus, when the top cap 50 is placed on the rafter beam 20 to be secured thereto, the securement positioning channel 54 of the top cap 50 is placed over the threaded channel 28 of the rafter beam 20 such that channel walls 26 of the thread channel 28 fit within the securement channel walls 54A, 54B to align the securement indention 52C with the thread channel 28 for inserting one or more fasteners through pre-drilled holes (not shown) in the securement indention 52C and into the thread channel 28. Additionally, the fitting of the securement channel walls 54A, 54B of the securement positioning channel 54 of the top cap 50 over the channel walls 26 of the thread channel 28 of the rafter beam 20 can also align the gasket attachment channels 58A, 58B for securing top gaskets 60A of the gaskets 60 to the top cap 50 with the gasket attachment channels 34A, 34B of the rafter beam 20 for securing bottom gaskets 60B of the gaskets 60 to the rafter beam 20. This alignment of the top gasket attachment channels 58A, 58B with bottom gasket attachment channels 34A, 34B of the rafter beam 20 ensure proper securement and sealing of the roofing panels 40 and the roofing system 10B that forms a roofing structure for a building structure BS.

To form the top gasket attachment channels 58A, 58B, each top cap 50 can comprise top gasket channel walls 57 extending downward from the bottom portion 56 of the top cap 50. The top gasket channel walls 57 can be positioned on the first and second flange 52A, 52B of the top cap 50 forming top gasket attachment channels 58A, 58B on both sides of the top cap 50 to align with the gasket attachment channels 34A, 34B of the rafter beam 20 when the top cap 50 is secured thereto. In particular, as in the embodiments shown in FIGS. 15A and 15B, the top cap 50 can have a first top gasket attachment channel 58A on the first flange 52A of the rafter beam 20 and a second top gasket attachment channel 58B on the second flange 52B of the top cap 50 to accommodate top gaskets 60A for securement of roofing panels 40 on either side of the top cap 50. Depending on where the top cap 50 is used in the roofing system 10, for example, if the top cap 50 is a beam that forms an end edge of the roofing system 10, the outer top gasket attachment channel 58A, 58B can be used for securing the end fin 16 to the respective top cap 50. Each of the top gasket attachment channels 58A, 58B of the respective top cap 50 can be formed as an integral part of the respective top cap 50 during the extrusion process. As shown in FIGS. 15A and 15B, the top gasket channel walls 57 can have lips 57A that extend farther inward into the channel than the base of the top gasket channel walls 57 such that the base of the respective top gasket attachment channel 58A, 58B is wider than an entrance of the respective top gasket attachment channel 58A, 58B. As with the gasket channels of the rafter beam 20, these configurations of the top gasket attachment channels 58A, 58B create a holding mechanism for securing top gaskets 60A or end fins 16 to the top cap 50 with an easy-to-use sliding engagement.

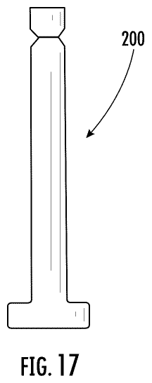

FIG. 17 illustrates a side plan view of an embodiment of an edge strip 200. Each of the one or more gasket attachment channels can be used for securing an edge strip 200 to the respective rafter beam. The edge strip 200 can have a perforation to break an end piece from an end of the edge strip 200 so that a same part can be used for a 30 mm solar panel or a 35 mm solar panel.

The roofing system 10B can further comprise roofing panel gaskets 60 for sealing the roofing panels as shown in FIGS. 10B-11C and 13A-15B. The gaskets 60 can comprise stepped gaskets when using shorter roof panels that overlap or a flat gasket (discussed below). The gaskets 60 can comprise a rubber. For example, the gaskets 60 can comprise a synthetic rubber. In some embodiments, the gaskets 60 can comprise an ethylene propylene diene monomer rubber (EPDM) that can provide a seal between the gaskets 60 and the roofing panels 40 and be sturdy enough to support the roofing panels 40 between the structural beams 20 and the top caps 50 and generally be expected to last the life of the roof structure. For example, the gaskets 60 can be top gaskets 60A or bottom gaskets 60B depending on how the gaskets 60 are oriented and which of the gasket attachment channels 34A, 34B, 58A, 58B the gaskets 60 engage.

Referring to FIGS. 5A and 5B, the roofing panel gasket 60 can comprise a longitudinal base 62 having a first side 62A and a second side 62B running the length of the base 62. An engagement rail 64 can extend outward from the first side 62A of the base 62. The engagement rail 64 can be configured to attachably engage a respective gasket attachment channel 34A, 34B, 58A, 58B in either a rafter beam 20 or a top cap 50 of a roofing system 10. For example, in some embodiments, the engagement rail 64 can comprise a rail track 64A that can be inserted into a base of a gasket attachment channel 34A, 34B, 58A, 58B and a stem 64B that extends between the longitudinal base 62 and the rail track 64A. The rail track 64A can be larger in width than at least a lower portion of the stem 64B such the rail track 64A can slidably fit within a base of a gasket attachment channel 34A, 34B, 58A, 58B while the lower portion of the stem 64B can slidably fit between the respective lips 32A, 57A of the gasket channel walls 32, 57 of the respective gasket attachment channels 34A, 34B, 58A, 58B.

Each roofing panel gasket 60 can comprise a sealing body 66 that can extend upward from the second side 62B of the longitudinal base 62. The sealing body can comprise a flat surface to form a flat gasket. The gaskets 60 can comprise adhesive flat gaskets that adhere between the modules along the long edge where it does not rest on the structure framing system to make a watertight seal.

The roofing system 10B can comprise end fins 16, 18 attachable to the structural beams 20 and the top caps 50 to enclose end edges 12, 14 of the roofing system 10B as shown in FIGS. 1B and 10. The end fins 16, 18 can overlap to form a seal at the end edges 12, 14. In some embodiments, the end fins 16, 18 can comprise a metal. In some embodiments, the end fins 16, 18 can comprise a plastic. For example, in some embodiments, the end fins 16, 18 can comprise a hard plastic or metal that can provide a seal at end edges 12, 14 of the roofing system 10B and be sturdy enough to generally be expected to last the life of the roofing system 10.

In some embodiments as shown in FIGS. 10A-10C, the roofing panels, such as solar modules or insulated roofing panels, can be secured side-by-side instead of stepped. For example, FIG. 10A shows two solar modules 42 can be placed on a gasket in a structural beam beside each other in close proximity. A panel seal 90 can be secured between the two solar modules 42 sealing the two solar modules 42 together. The panel seal 90 can comprise a sealer 92A, 92B, such commercial/roofing seam tape or a double-sided butyl tape, and a T-seal 94 that comprises a lateral top that extends over an end portion of the of the top of the two solar modules 42 and a tail that extends between the adjacent ends of the two solar modules 42. In some embodiments, the tape 92A can be placed over the top end portion and a portion of the end of the first solar module 42 and the tape 92B can be placed over the top end portion and a portion of the end of the second solar module 42. The T-seal 94, which can comprise a metal such as aluminum in the form of a T-bracket, can be press fit against the strips of tape 92A, 92B, on the top end portions and portions of the ends of the solar modules 42 to seal the gap between the two solar modules 42. Alternatively, the T-seal 94 can have the tape 92A, 92B, secured beneath the top of the T-seal 94 on either side of the tail of the T-seal 94. The solar modules 42 can be placed in a side-by-side configuration and the T-seal 94 with its tail and the tape 92A, 92B facing downward can be press fit between the two solar modules 42 to secure the T-seal 94 to the top of the end portions and the ends of the two solar modules 42 to seal the gap between the two solar modules 42. While the use of the panel seal 90 where roofing panels are placed side-by-side have been described with reference to solar modules 42, the panel seals 90 can be used with insulated roofing panels or a combination of different roofing panels. The tape 92A, 92B can be positioned on the T-seal 94 in such a way so as to limit the exposure of the tape to the elements once solar modules 42 or roofing panels and panel seal 90 are installed.

As shown in FIG. 10B, gaskets 60C′ and 60D′ used in sealing the sides of the roofing system where the roofing panels 40 engage the structural beams can comprise a different shape from the stepped gaskets shown in FIGS. 5A,11A and 11B. The top roofing panel gasket 60C′ and the bottom roofing panel gasket 60D′ can be the same or similar in shape, length, and thickness and can be described with reference to gasket 60′ shown in side profile in FIG. 10C. The gasket 60′ can comprise a longitudinal base 62′ having a first side 62A′ and a second side 62B′ running the length of the base 62′. An engagement rail 64′ can extend outward from the first side 62A′ of the base 62′. The engagement rail 64′ can be configured to attachably engage a respective gasket attachment channel 34A, 34B, 58A, 58B in either a rafter beam 20 or a top cap 50 of a roofing system 10. For example, in some embodiments, the engagement rail 64′ can comprise a rail track 64A′ that can be inserted into a base of a gasket attachment channel 34A, 34B, 58A, 58B and a stem 64B that extends between the longitudinal base 62′ and the rail track 64A′. The rail track 64A′ can be larger in width than at least a lower portion of the stem 64B′ such the rail track 64A′ can slidably fit within a base of a gasket attachment channel 34A, 34B, 58A, 58B while the lower portion of the stem 64B′ can slidably fit between the respective lips 32A, 57A of the gasket channel walls 32, 57 of the respective gasket attachment channels 34A, 34B, 58A, 58B.

Each roofing panel gasket 60′ can also comprise a sealing body 66′ that can extend upward from the second side 62B′ of the longitudinal base 62′. The sealing body 66′ can comprise a flat surface to form a flat gasket as shown FIG. 10B (see top and bottom gaskets 60C′, 60D′). As shown in FIG. 10C, in some embodiments, the sealing body 66′ can comprise vertical sealing layers 68′. The vertical layers 68′ can each have the stepped longitudinal profile of the sealing body 66′. The vertical layers 68′ can create a better and longer lasting seal between roofing panel gasket 60′ and the roofing panels 40′. In some embodiments, the sealing body 66′ may not employ such vertical sealing layers 68′. In some embodiments, the gaskets 60′ can comprise adhesive flat gaskets that adhere between the modules along the long edge where it does not rest on the structure framing system to make a watertight seal.

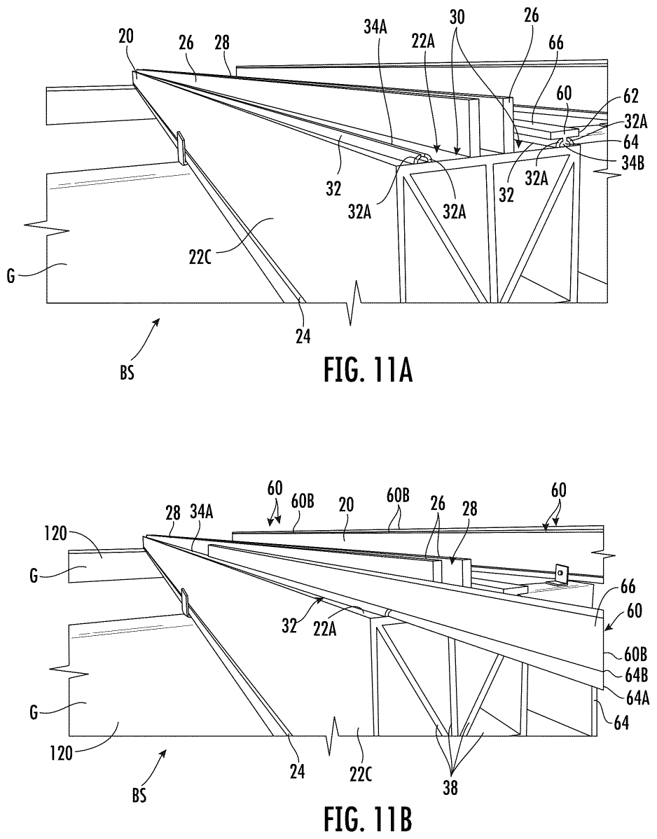

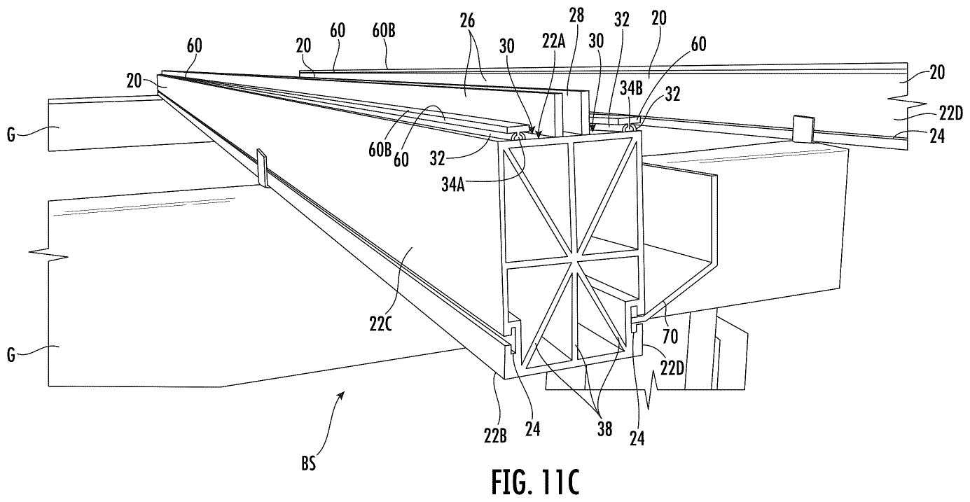

The bottom flat gaskets 60D′, for example, as shown in FIG. 10B, can form the bottom seal against the roofing panels such as solar modules 42 and can be slid into the gasket attachment channels 34A, 34B of the top wall 22A of the rafter beam 20 similarly to the gaskets being slid into the gasket attachment channels as shown in FIGS. 11A-11C. As stated above, the bottom gaskets 60D′ are positioned along the span of the length of the respective structural beams 20 to received roofing panels 40 such as solar modules 42, for example, by inserting engagement rail 64D′ of the respective bottom flat gaskets 60D′ in the gasket channel of the respective structural beam with the flat sealing body 66D′ extending from the base 62D′ and facing outward to engage the solar modules 42 as shown in FIG. 10B. The top flat gaskets 60C′ can form the top seal against the roofing panels such as solar modules 42. The top caps 50 may also be prepared by inserting engagement rail 64C′ of top gaskets 60C′ into the gasket attachment channels 58A, 58B of the top caps 50 so that the flat sealing body 66D′ extending from the base 62D′ face outward in preparation of attachment of the top caps 50 to the structural beams 20 over the roofing panels, such as solar modules 42. Since the top and bottom gaskets 60C′, 60D′ are flat, the roofing panels such as solar modules 42 can be positioned side-by-side with a panel seal 90, such a T-seal 94, secured between solar modules 42 and overlapping top and portions of the side-by side solar modules 42.

The solar modules 42 that can comprise the roofing panels 40 of a building structure can be positioned on one or more bottom flat gaskets 60D′ as shown in FIG. 10B. The wiring and optimizers and/or microinverters can be attached to the solar modules 42 to permit the solar modules 42 to operate properly once the system is activated as described above. A panel seal 90, such a T-seal 94, can be secured between solar modules 42 and overlapping top and portions of the side-by side solar modules 42. Top caps, as described above with reference to top caps 50, with one or more top flat gaskets 60C′ as shown in FIG. 10B installed thereon can then be placed over the solar modules 42 and secured to the structural beam as described above with the solar modules 42 sandwiched between the top flat gasket 60C′ and the bottom flat gasket 60D′ as shown in FIG. 10B. Fasteners can be used to secure the top caps to the structural beams as described above.

The disclosure above also provides a method of assembling a frame system with a variety of different steps or variations as outlined above. Generally, a method can be provided that can include providing components of a frame system. The frame system components can comprise a plurality of post beams with each of the post beams of the plurality of post beams comprising a plurality of side walls and having one or more post slots along at least a first side wall of the plurality of side walls of the post beam. The frame system components can comprise a plurality of post bases corresponding to the plurality of post beams. Each of the post bases can comprise a base body having a plurality of side walls and a post aperture at a top of the post base. Each of the post bases can comprise one or more base slots in the first side wall of the plurality of side walls of the post beam. Additionally, the frame system components can comprise a plurality of frame beams. Each of the frame beams of the plurality of frame beams comprises a plurality of side walls and having one or more frame slots along at least a first side wall of the plurality of side walls of the frame beam. The frame system components can also comprise a plurality of T-frames and a plurality of brackets. Each T-frame can have a post receiving aperture and a frame beam groove positioned above the post receiving aperture. The plurality of brackets can be used to secure corresponding post beams of the plurality of post beams and corresponding frame beams of the plurality of frame beams together. The method can comprise securing the plurality of post base to a surface and positioning a corresponding post beam of the plurality of post beams in a post aperture in a corresponding post base of the plurality of post bases. The one or more post slots can be aligned with the one or more base slots. Each of the corresponding post beam of the plurality of post beams can then be secured to the corresponding post base of the plurality of post bases as described above. Each T-frame of the plurality of T-frames can be secured on a corresponding post beam of the plurality of post beams by positioning the post receiving aperture of each T-frame of the plurality of T-frames around a top end of the corresponding post beam of the plurality of post beams and securing each T-frame of the plurality of T-frames around the top end of the corresponding post beam of the plurality of post beams. Once the T-frames are secured, one or more frame beams of the plurality of frame beams can be placed and secured in a corresponding frame beam groove of the plurality of T-frames. At least some of the frame beams of the plurality of frame beams can be secured to corresponding post beams of the plurality of post beams using the plurality of brackets.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

1-46. (canceled)

47. A frame system comprising:
a plurality of post beams, each of the post beams of the plurality of post beams comprising a plurality of side walls and having one or more post slots along at least a first side wall of the plurality of side walls of the post beam;
a plurality of post bases corresponding to the plurality of post beams, each of the post bases comprising:
a base body having a plurality of side walls and an aperture at a top of the post base for receiving a corresponding post beam of the plurality of post beams; and
one or more base slots that are alignable with the one or more post slots in the first side wall of the plurality of side walls of the post beam;
a plurality of frame beams, each of the frame beams of the plurality of frame beams comprising a plurality of side walls and having one or more frame slots along at least a first side wall of the plurality of side walls of the frame beam;
a plurality of T-frames, each T-frame configured to extend upward from a top end of a corresponding post beam of the plurality of post beams, each T-frame having a post receiving aperture for receiving the top end of the corresponding post beam and a frame beam groove positioned above the post receiving aperture for receiving one or more frame beams of the plurality of frame beams; and
a plurality of brackets for securing corresponding post beams of the plurality of post beams and corresponding frame beams of the plurality of frame beams together.

48. The frame system according to claim 47, wherein each of the post beams comprises one or more post slots along a second side wall of the post beam opposite the first side wall of the respective post beam.

49. The frame system according to claim 48, wherein the one or more post slots in the plurality of post beams and the one or more frame slots in the plurality of frame beams comprise T-bolt slots configured to receive T-bolts for facilitating the securement of the plurality of post beams, the plurality of post bases, the plurality of frame beams, the plurality of T-frames and plurality of brackets into a desired structure.

50. The frame system according to claim 48, wherein each post base of the plurality of post bases further comprising a base shelf extending from at least one of the side walls of the post base configured to support a bottom end of the corresponding post beam.

51. The frame system according to claim 50, wherein each post base of the plurality of post bases comprises one or more base slots along a second side wall of the side walls of the post base opposite the first side wall of the post base, the one or more base slots along the first and second side walls in the post base being positioned above the base shelf with the one or more base slots in the first side of the base being alignable with one or more post slots in the first side wall of a respective post beam of the plurality of post beams and the one or more base slots in the second side of the base being alignable with the one or more post slots in the second side wall of the respective post beam.

52. The frame system according to claim 48, wherein each of the post beams comprises a first channel configured for receiving direct current (DC) wiring and a second channel configured for receiving alternating current (AC) wiring.

53. The frame system according to claim 52, wherein each of first and second channels of the post beams comprise a cavity that is open on top and bottom ends of the respective post beam.

54. The frame system according to claim 53, wherein each post base of the plurality of post bases comprises a bottom wall that includes a first aperture therein configured for receiving direct current (DC) wiring and a second aperture therein configured for receiving alternating current (AC) wiring.

55. (canceled)

56. The frame system according to claim 48, wherein each post beam of the plurality of post beams comprises a plurality of structural beams secured to each other to form the respective post beam.

57. The frame system according to claim 56, wherein the plurality of structural beams comprise two outward facing structural beams, with a first of the two outward facing structural beams having a front side wall forming the first side wall of the post beam and a second of the two outward facing structural beams having a front side wall forming the second side wall of the post beam and each of the first and second outward facing structural beams having a back side wall of the structural beam having a rail and slot that extend from a first end of the respective structural beam to a second end on the back side wall and each of the front side walls of the two outward facing structural beams having a post slot of the one or more post slots of the respective first side wall of the post beam or the second side wall of the post beam therein.

58. The frame system according to claim 57, wherein the rail and the slot on the back wall of the first of the two outward facing structural beams are configured to engage the slot and the rail on the back wall of the second of the two outward facing structural beams to form the respective post beam of the plurality of post beams such that the one or more post slots extend along the first side wall of the post beam and along the second side wall opposite the first side wall of the post beam.

59. The frame system according to claim 57, wherein the plurality of structural beams comprises one or more center structural beams, each center structural beam comprising a first side wall and an opposing second side wall with each of the first and second side walls having a rail and slot that extend from a first end of the respective center structural beam to a second end of the respective center structural beam, the rails and slots on the first and second side walls of each center structural beam configured to engage the rails and slots of the first outward facing structural beams, the second outward facing structural beam, or another of the center structural beams.

60. The frame system according to claim 47, wherein each of the frame beam of the plurality of the frame beams comprises a plurality of structural beams secured to each other to form the respective frame beam.

61. The frame system according to claim 60, wherein the plurality of structural beams comprise two outward facing structural beams, with a first of the two outward facing structural beams having a front side wall forming the first side wall of the frame beam and a second of the two outward facing structural beams having a front side wall forming the second side wall of the frame beam and each of the first and second outward facing structural beams having a back side wall of the structural beam having a rail and slot that extend from a first end of the respective structural beam to a second end on the back side wall and each of the front side walls of the two outward facing structural beams having a post slot of the one or more post slots of the respective first side wall of the post beam or the second side wall of the post beam therein.

62. The frame system according to claim 61, wherein the rail and the slot of a first of the two outward facing structural beams are configured to engage the slot and the rail of a second of the two outward facing structural beams to form a frame beam of the plurality of frame beams that comprises the one or more frame slot along the first side wall of the frame beam and one or more frame slots along a second side wall opposite the first side wall of the frame beam.

63. The frame system according to claim 47, wherein each T-frame of the plurality of T-frames comprises a post sleeve in which the post receiving aperture resides, the post sleeve comprises side walls with a first side wall of the side walls having one or more slots therein that are alignable with the one or more post slots in the first side wall of the plurality of side walls of the post beam to secure the T-frame to a respective post beam of the plurality of post beams.

64. The frame system according to claim 63, wherein the frame beam groove extends above the post sleeve of each T-frame, the frame beam groove comprising a bottom groove wall and a first groove side wall and a second groove side wall extending upward from opposing sides of the bottom groove wall.

65. (canceled)

66. The frame system according to claim 64, wherein the bottom groove wall of the frame beam groove comprises a first bottom groove wall that extends from a top of the post sleeve perpendicular to a first wall of a walls of the post sleeve and a second bottom groove wall that extends from a top of the post sleeve perpendicular to a second wall of the walls of the post sleeve with the first bottom groove wall and the second bottom groove wall each having one or more slots therein that are alignable with the one or more frame slots in the first side wall of one or more frame beams of the plurality of frame beams to secure the T-frame to the one or more respective frame beams of the plurality of frame beams.

67. (canceled)

68. The frame system according to claim 47, wherein each bracket of the plurality of brackets comprises a bracket body with a first flange extending from the bracket body.

69. The frame system according to claim 68, wherein the bracket body extends in a first plane and the first flange extends from the bracket body in a second plane perpendicular to the first plane.

70. The frame system according to claim 69, wherein the bracket body comprise one or more slots therein that are alignable with the one or more post slots in the first side wall of the respective post beam of the plurality of post beams and the first flange having one or more slots therein that are alignable with the one or more frame slots in the first side wall of the respective frame beam of the plurality of frame beams to secure the post beam and frame beam together.

71. (canceled)

72. The frame system according to claim 48, further comprises a plurality of U brackets, each U bracket of the plurality of U brackets comprising a bottom wall having one or more slots therein that are alignable with one or more frame slots in a second side wall of a frame beam of the plurality of frame beams for securing the U brackets to the respective frame beam and each U bracket of the plurality of U brackets comprising a first side wall and a second side wall that extend upward from opposing sides of the bottom wall of the U bracket, the first and second side walls and the bottom wall forming a channel for receiving a rafter beam of the plurality of rafter beams for securing the rafter beam to the frame beam.

73. The frame system according to claim 72, wherein the first side wall of the U bracket comprises a first curved slot and a second curved slot that extend through a top end of the first side wall of the U bracket with the first and second slots curving toward each other at top portions of the first and second curved slots and the second side wall of the U bracket comprises a first curved slot and a second curved slot that extend through a top end of the second side wall of the U bracket with the first and second slots curving toward each other at top portions of the first and second curved slots.

74. (canceled)

75. The frame system according to claim 47, further comprises a wall bracket configured to be secured to another structure and to a post beam of the plurality of post beams.

76. The frame system according to claim 75, wherein the wall bracket has a first side wall that has one or more securement apertures for receiving fasteners for securement to a structure and second and third side walls that extend from the first side wall, the second and third side walls each having one or more slots therein, the one or more slots in the second side wall of the wall bracket being alignable with the one or more post slots in a first side wall of a post beam of the plurality of post beams and the one or more slots in the third side wall of the wall bracket being alignable with the one or more post slots along a second side wall of the post beam opposite the first side wall of the post beam.

77. A method of assembling a frame system comprising:
providing components of a frame system, the frame system components comprising:
a plurality of post beams, each of the post beams of the plurality of post beams comprising a plurality of side walls and having one or more post slots along at least a first side wall of the plurality of side walls of the post beam;
a plurality of post bases corresponding to the plurality of post beams, each of the post bases comprising:
a base body having a plurality of side walls and a post aperture at a top of the post base; and
one or more base slots in the first side wall of the plurality of side walls of the post beam;
a plurality of frame beams, each of the frame beams of the plurality of frame beams comprising a plurality of side walls and having one or more frame slots along at least a first side wall of the plurality of side walls of the frame beam;
a plurality of T-frames, each T-frame having a post receiving aperture and a frame beam groove positioned above the post receiving aperture; and
a plurality of brackets for securing corresponding post beams of the plurality of post beams and corresponding frame beams of the plurality of frame beams together;
securing the plurality of post base to a surface;
positioning a corresponding post beam of the plurality of post beams in a post aperture in a corresponding post base of the plurality of post bases;
aligning the one or more post slots with the one or more base slots and securing each of the corresponding post beam of the plurality of post beams to the corresponding post base of the plurality of post bases;
securing each T-frame of the plurality of T-frames on a corresponding post beam of the plurality of post beams by positioning the post receiving aperture of each T-frame of the plurality of T-frames around a top end of the corresponding post beam of the plurality of post beams and securing each T-frame of the plurality of T-frames around the top end of the corresponding post beam of the plurality of post beams;
placing and securing one or more frame beams of the plurality of frame beams in a corresponding frame beam groove of the plurality of T-frames; and
securing at least some of the frame beams of the plurality of frame beams to corresponding post beams of the plurality of post beams using the plurality of brackets.
